(19) United States
(12) Patent Application Publication
(10) Pub. No.: US 2025/0155757 A1
(43) Pub. Date: May 15, 2025

(54) LIQUID CRYSTAL DISPLAY DEVICE

(71) Applicant: Shanghai Tianma Micro-Electronics Co., Ltd., Shanghai (CN)

(72) Inventors: Tomomi HONDA, Kawasaki (JP); Hidenori Ikeno, Kawasaki (JP)

(73) Assignee: Shanghai Tianma Micro-Electronics Co., Ltd., Shanghai (CN)

(21) Appl. No.: 18/939,833

(22) Filed: Nov. 7, 2024

(30) Foreign Application Priority Data
Nov. 14, 2023 (JP) 2023-193754

(51) Int. Cl. G02F 1/1347; G02F 1/1335; G02F 1/1343; G02F 1/1345

(52) U.S. Cl. CPC G02F 1/1347; G02F 1/133512; G02F 1/134309; G02F 1/1345

(57) ABSTRACT

A liquid crystal display device includes a first liquid crystal display panel, and a second liquid crystal display panel includes a light blocking pattern. The light blocking pattern includes a first light blocking line that extends in a predetermined direction, the first light blocking line including a first incline inclined with respect to the predetermined direction and a second incline inclined in a direction opposite the first incline with respect to the predetermined direction, and a second light blocking line that is adjacent to the first light blocking line and that is line-symmetrical, with respect to the predetermined direction, to the first light blocking line. The second liquid crystal display panel has a pixel electrode, the pixel electrode having a plurality of tooth portions and a connector that connects the plurality of tooth portions, and the connector overlaps the first light blocking line or the second light blocking line.

This application claims the benefit of Japanese Patent Application No. 2023-193754, filed on Nov. 14, 2023, the entire disclosure of which is incorporated by reference herein.

### FIELD OF THE INVENTION

The present disclosure relates generally to a liquid crystal display device.

### BACKGROUND OF THE INVENTION

In the related art, liquid crystal display devices are known in which a plurality of liquid crystal panels are stacked to improve contrast. For example, Unexamined Japanese Patent Application Publication (Translation of PCT Application) No. 2021-535415 describes a display panel that includes a display liquid crystal panel and a light control panel.

In Unexamined Japanese Patent Application Publication (Translation of PCT Application) No. 2021-535415, the display liquid crystal panel realizes a display function, and the light control panel controls the light that enters the display liquid crystal panel from a backlight. The light control panel includes a plurality of signal lines (gate lines and data lines). At least a portion of the plurality of signal lines is a polygonal line. Moiré of the display panel is improved by configuring the signal lines of the light control panel as polygonal lines to form the signal lines of the light control panel and grid lines (gate lines and data lines) of the display liquid crystal panel in different patterns.

If comb-teeth-shaped pixel electrodes are joined with bent signal lines such as the ones in Unexamined Japanese Patent Application Publication (Translation of PCT Application) No. 2021-535415, moiré may occur due to interference between dark lines generated in areas where liquid crystal molecules do not rotate upon voltage being applied and the grid lines of the display liquid crystal panel. For example, in a pixel electrode including bent tooth portions and a connector connecting the bent tooth portions, the liquid crystal molecules do not rotate in the vicinity of the connector, the bent portions of the tooth portions, the boundary between adjacent pixel electrodes, and the like.

### SUMMARY OF THE INVENTION

A liquid crystal display device according to a first aspect of the present disclosure includes:
a first liquid crystal display panel having a first main pixel; and
a second liquid crystal display panel having a second main pixel corresponding to a plurality of the first main pixels and a light blocking pattern that is repeatedly arranged and has light blocking properties, and overlapping the first liquid crystal display panel, wherein
the light blocking pattern includes a first light blocking line that extends in a predetermined direction, the first light blocking line including a first incline inclined with respect to the predetermined direction and a second incline inclined in a direction opposite the first incline with respect to the predetermined direction, and a second light blocking line that is adjacent to the first light blocking line and that is line-symmetrical, with respect to the predetermined direction, to the first light blocking line,
the second main pixel has a pixel electrode, the pixel electrode having a plurality of tooth portions and a connector connecting the plurality of tooth portions,
at least one of the first light blocking line or the second light blocking line is formed from one of a scan wiring and a signal wiring of the second liquid crystal display panel, and
when viewed in plan, the connector overlaps the first light blocking line or the second light blocking line.

A liquid crystal display device according to a second aspect of the present disclosure includes:
an element having an electrode or a light shield; and
a liquid crystal display panel having a main pixel and a light blocking pattern that is repeatedly arranged and has light blocking properties, and overlapping the element, wherein
the light blocking pattern includes a first light blocking line that extends in a predetermined direction, the first light blocking line including a first incline inclined with respect to the predetermined direction and a second incline inclined in a direction opposite the first incline with respect to the predetermined direction, and a second light blocking line that is adjacent to the first light blocking line and that is line-symmetrical, with respect to the predetermined direction, to the first light blocking line,
the main pixel has a pixel electrode, the pixel electrode having a plurality of tooth portions and a connector connecting the plurality of tooth portions,
at least one of the first light blocking line or the second light blocking line is formed from one of a scan wiring and a signal wiring of the liquid crystal display panel, and
when viewed in plan, the connector overlaps the first light blocking line or the second light blocking line.

It is to be understood that both the foregoing general description and the following detailed description are exemplary and explanatory and are not restrictive of this disclosure.

### BRIEF DESCRIPTION OF DRAWINGS

A more complete understanding of this application can be obtained when the following detailed description is considered in conjunction with the following drawings, in which:

FIG. 1 is a schematic drawing illustrating a liquid crystal display device according to Embodiment 1;

FIG. 2 is a plan view illustrating a first liquid crystal display panel according to Embodiment 1;

FIG. 3 is a cross-sectional view illustrating the liquid crystal display device according to Embodiment 1;

FIG. 4 is a plan view illustrating a second liquid crystal display panel according to Embodiment 1;

FIG. 5 is a schematic drawing illustrating a first light blocking pattern and a second light blocking pattern according to Embodiment 1;

FIG. 6 is a schematic drawing illustrating the first light blocking pattern, the second light blocking pattern, and main pixels of the first liquid crystal display panel, corresponding to one main pixel of the second liquid crystal display panel according to Embodiment 1;

FIG. 7 is a plan view illustrating scan wirings, signal wirings, switching elements, and a pixel electrode of the second liquid crystal display panel according to Embodiment 1;

FIG. 8 is a cross-sectional view illustrating a switching element and a contact hole of the second liquid crystal display panel according to Embodiment 1;

FIG. 9 is a plan view illustrating a pixel electrode according to Embodiment 1;

FIG. 10 is a drawing for explaining dark lines in a state in which voltage is applied on liquid crystal according to Embodiment 1;

FIG. 11 is a schematic drawing illustrating dark lines in a state in which voltage is applied on liquid crystal according to Embodiment 1;

FIG. 12 is a schematic drawing illustrating dark lines in a state in which voltage is applied on liquid crystal according to Comparative Example 1;

FIG. 13 is a drawing illustrating an angle of a viewing direction according to Embodiment 1;

FIG. 14 is a drawing illustrating relationships between the angle of the viewing direction and brightness of a liquid crystal display device according to Embodiment 1 and brightness according to Comparative Example 1 in a state in which a white color is displayed;

FIG. 15 is a block diagram illustrating a display controller according to Embodiment 1;

FIG. 16 is a plan view illustrating scan wirings, signal wirings, switching elements, and pixel electrodes of the second liquid crystal display panel according to Embodiment 2;

FIG. 17 is a schematic drawing illustrating dark lines in a state in which voltage is applied on liquid crystal according to Embodiment 2;

FIG. 18 is a plan view illustrating scan wirings, signal wirings, switching elements, and pixel electrodes of the second liquid crystal display panel according to Embodiment 3;

FIG. 19 is a plan view illustrating pixel electrodes according to Embodiment 3;

FIG. 20 is a schematic drawing illustrating dark lines in a state in which voltage is applied on liquid crystal according to Embodiment 3;

FIG. 21 is a schematic drawing illustrating a liquid crystal display device according to Embodiment 4;

FIG. 22 is a plan view illustrating a touch panel according to Embodiment 4;

FIG. 23 is a plan view illustrating a second liquid crystal display panel according to Embodiment 4;

FIG. 24 is a plan view illustrating scan wirings, signal wirings, switching elements, and pixel electrodes of the second liquid crystal display panel according to Embodiment 4;

FIG. 25 is a schematic drawing illustrating dark lines in a state in which voltage is applied on liquid crystal according to Embodiment 4;

FIG. 26 is a schematic drawing illustrating dark lines in a state in which voltage is applied on liquid crystal according to Comparative Example 2;

FIG. 27 is a schematic drawing illustrating a liquid crystal display device according to Embodiment 5;

FIG. 28 is a cross-sectional view illustrating a cross-section of a liquid crystal lens according to Embodiment 5;

FIG. 29 is a schematic drawing illustrating a third electrode, a fourth electrode, and light shields of the liquid crystal lens according to Embodiment 5;

FIG. 30 is a plan view illustrating a second liquid crystal display panel according to Embodiment 5;

FIG. 31 is a plan view illustrating scan wirings, signal wirings, switching elements, and pixel electrodes of the second liquid crystal display panel according to Embodiment 5;

FIG. 32 is a schematic drawing illustrating dark lines in a state in which voltage is applied on liquid crystal according to Embodiment 5;

FIG. 33 is a plan view illustrating a pixel electrode according to a modified example;

FIG. 34 is a schematic drawing illustrating a second main pixel and pixel electrodes according to a modified example; and

FIG. 35 is a schematic drawing illustrating a parallax barrier panel according to a modified example.

### DETAILED DESCRIPTION OF THE INVENTION

Hereinafter, a liquid crystal display device according to various embodiments is described while referencing the drawings.

### Embodiment 1

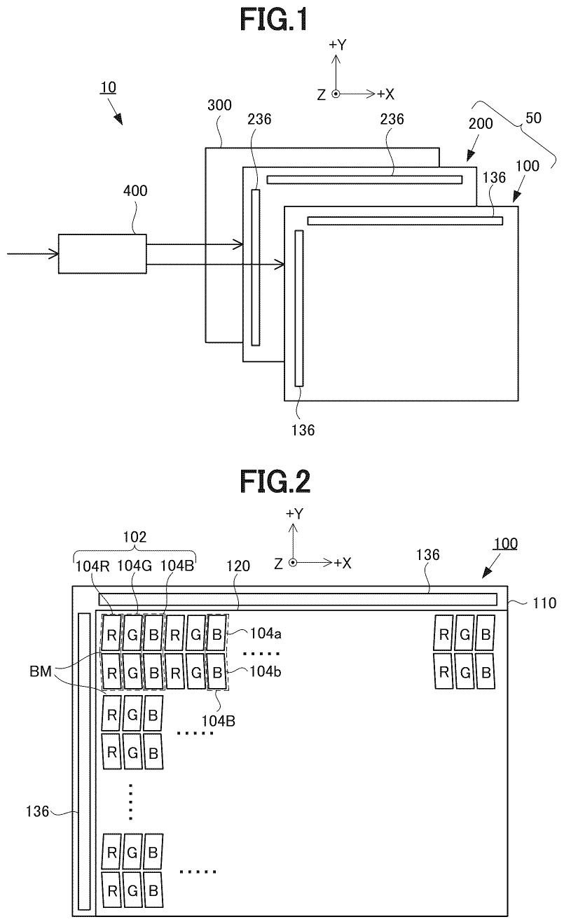

A liquid crystal display device 10 according to the present embodiment is described while referencing FIGS. 1 to 15. The liquid crystal display device 10 displays a color display element (characters, images, and the like) using a first liquid crystal display panel 100 and a second liquid crystal display panel 200, described later.

As illustrated in FIG. 1, the liquid crystal display device 10 includes a panel section 50, a backlight 300, and a display controller 400. The panel section 50 includes the first liquid crystal display panel 100 and the second liquid crystal display panel 200. The backlight 300 is a light source that emits light on the first liquid crystal display panel 100 and the second liquid crystal display panel 200. The display controller 400 controls the displays of the first liquid crystal display panel 100 and the second liquid crystal display panel 200. Note that, in the present description, to facilitate comprehension, in the liquid crystal display device 10 of FIG. 1, the right direction (the right direction on paper) is referred to as the “+X direction”, the up direction (the up direction on paper) is referred to as the “+Y direction”, and the direction perpendicular to the +X direction and the +Y direction (the front direction on paper) is referred to as the “+Z direction.”

### Panel Section

The panel section 50 includes the first liquid crystal display panel 100 and the second liquid crystal display panel 200. The first liquid crystal display panel 100 is positioned on an observer side (the +Z side) and displays a color display element. The second liquid crystal display panel 200 is positioned on a side, opposite the surface of the observer side, of the first liquid crystal display panel 100 (a back surface side of the first liquid crystal display panel 100), and overlaps the first liquid crystal display panel 100. The second liquid crystal display panel 200 displays a monochrome display element.

### First Liquid Crystal Display Panel

In one example, the first liquid crystal display panel 100 is implemented as a known transmissive horizontal electric field type liquid crystal display panel. The first liquid crystal display panel 100 is active matrix driven by thin film transistors (TFT).

As illustrated in FIG. 2, the first liquid crystal display panel 100 includes first main pixels 102 arranged in a matrix. The first main pixel 102 includes a red pixel 104R that transmits red light, a green pixel 104G that transmits green light, and a blue pixel 104B that transmits blue light that are defined in a V-shape by a black matrix BM. Note that the red pixel 104R, the green pixel 104G, and the blue pixel 104B may be referred to collectively as a “subpixel 104.”

The subpixel 104 is divided into two domains 104a, 104b having a different rotation direction of a first liquid crystal 130. The domain 104a and the domain 104b are defined by the black matrix BM.

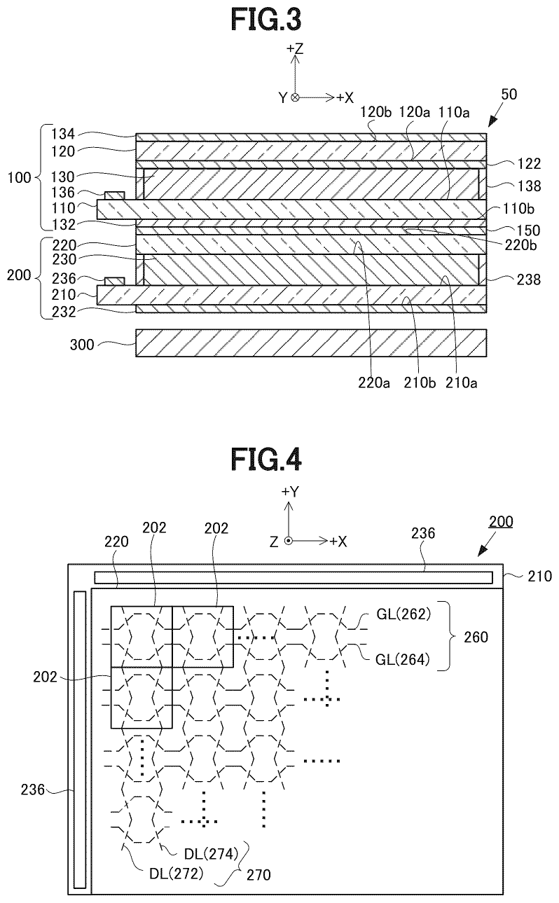

As illustrated in FIG. 3, the first liquid crystal display panel 100 includes a first TFT substrate 110, a first counter substrate 120, a first liquid crystal 130, a first polarizing plate 132, a second polarizing plate 134, and a first driver circuit 136. The first TFT substrate 110 and the first counter substrate 120 sandwich the first liquid crystal 130. The first polarizing plate 132 is provided to the first TFT substrate 110. The second polarizing plate 134 is provided to the first counter substrate 120.

In one example, the first TFT substrate 110 is implemented as a glass substrate. On a main surface 110a of the first TFT substrate 110 on the first liquid crystal 130 side, TFTs for selecting the subpixels 104, a common electrode, pixel electrodes, and an alignment film for aligning the first liquid crystal 130 are provided (all not illustrated in the drawings).

Furthermore, a plurality of common wirings, a plurality of signal wirings, and a plurality of scan wirings (all not illustrated in the drawings) are formed on the main surface 110a of the first TFT substrate 110. The common wirings supply common potential to the common electrode that applies voltage to the first liquid crystal 130. The signal wirings supply, via the TFTs, voltage to the pixel electrodes that apply voltage to the first liquid crystal 130. The signal wirings extend in the Y direction and are bent along the V shape of the subpixels 104. The scan wirings supply voltage for operating the TFTs. The scan wirings extend linearly in the X direction. The subpixels 104 are surrounded by the signal wirings and the scan wirings, and the TFTs are provided at intersections of the scan wirings and the signal wirings. The first polarizing plate 132 is provided on a main surface 110b on the side opposite the main surface 110a of the first TFT substrate 110.

As illustrated in FIG. 3, the first counter substrate 120 opposes the first TFT substrate 110 and is adhered to the first TFT substrate 110 by a seal material 138. In one example, the first counter substrate 120 is implemented as a glass substrate. A color filter 122, the black matrix BM, an alignment film for aligning the first liquid crystal 130, and the like are provided on a main surface 120a on the first liquid crystal 130 side of the first counter substrate 120. In one example, the color filter 122 is implemented as a striped color filter in which color filters of the same color are disposed in the Y direction (color filter in which the stripe direction is the Y direction). A red color filter, a green color filter, and a blue color filter of the color filter 122 are each surrounded by the black matrix BM, and respectively correspond to the red pixel 104R, the green pixel 104G, and the blue pixel 104B. As illustrated in FIG. 2, the black matrix BM defines each first main pixel 102, each subpixel 104, and each domain 104a, 104b. The second polarizing plate 134 is provided on a main surface 120b on the side opposite the main surface 120a of the first counter substrate 120. Note that, to facilitate comprehension, the black matrix BM, the alignment film, and the like are omitted from FIG. 3.

As illustrated in FIG. 3, the first liquid crystal 130 is sandwiched between the first TFT substrate 110 and the first counter substrate 120. In one example, the first liquid crystal 130 is implemented as a positive nematic liquid crystal. The first liquid crystal 130 is aligned, by the alignment film, in a direction parallel to the main surface 110a of the first TFT substrate 110. Additionally, the first liquid crystal 130 rotates in a plane parallel to the main surface 110a of the first TFT substrate 110 due to voltage being applied.

The first polarizing plate 132 is provided on the main surface 110b of the first TFT substrate 110. The second polarizing plate 134 is provided on the main surface 120b of the first counter substrate 120. Either one of the transmission axis of the first polarizing plate 132 and the transmission axis of the second polarizing plate 134 is arranged parallel to the alignment direction of the first liquid crystal 130, and the transmission axis of the first polarizing plate 132 and the transmission axis of the second polarizing plate 134 are orthogonal to each other. The first polarizing plate 132 is adhered, by a light-transmitting adhesive layer 150, to a hereinafter described second counter substrate 220 of the second liquid crystal display panel 200. In one example, the adhesive layer 150 is implemented as an optical clear adhesive (OCA).

The first driver circuit 136 is provided on the main surface 110a of the first TFT substrate 110. The first driver circuit 136 supplies, on the basis of a color signal supplied from the display controller 400, voltage to the scan wirings, the signal wirings, and the common wirings.

### Second Liquid Crystal Display Panel

As illustrated in FIG. 3, the second liquid crystal display panel 200 is positioned on a back surface side (−Z side) of the first liquid crystal display panel 100, and is adhered to the first liquid crystal display panel 100 by the adhesive layer 150. The second liquid crystal display panel 200 displays a monochrome display element.

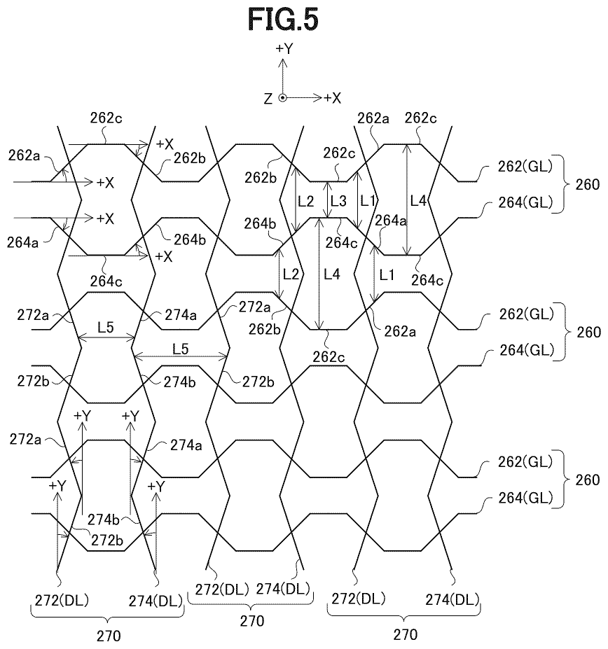

In the present embodiment, the second liquid crystal display panel 200 is implemented as a transmissive horizontal electric field type liquid crystal display panel that uses positive liquid crystal. The second liquid crystal display panel 200 is active matrix driven by hereinafter described switching elements 240. As illustrated in FIG. 4, the second liquid crystal display panel 200 includes second main pixels 202 arranged in a matrix. In the present embodiment, one second main pixel 202 of the second liquid crystal display panel 200 corresponds to 16 (4×4) first main pixels 102 of the first liquid crystal display panel 100. Specifically, one second main pixel 202 of the second liquid crystal display panel 200 transmits light from the backlight 300 towards 16 first main pixels 102 of the first liquid crystal display panel 100. Note that, in FIG. 4, the scan wirings GL and the signal wirings DL are illustrated as broken lines. In some of the drawings referred in the following as well, the scan wirings GL and the signal wirings DL may be illustrated as broken lines or solid lines.

As illustrated in FIG. 3, the second liquid crystal display panel 200 includes a second TFT substrate 210, a second counter substrate 220, a second liquid crystal 230, a third polarizing plate 232, and a second driver circuit 236. The second TFT substrate 210 and the second counter substrate 220 sandwich the second liquid crystal 230. The third polarizing plate 232 is provided to the second TFT substrate 210. Note that, in the present embodiment, the first polarizing plate 132 of the first liquid crystal display panel 100 also serves as a polarizing plate of the second liquid crystal display panel 200 on the light emission side. Note that the second liquid crystal display panel 200 of the present embodiment does not include a color filter.

In one example, the second TFT substrate 210 is implemented as a glass substrate. A plurality of scan wirings GL; a plurality of signal wirings DL; common wirings (not illustrated); switching elements 240, pixel electrodes 250, and common electrodes CE of the second main pixels 202; an alignment film (not illustrated) for aligning the second liquid crystal 230; and the like (all described later) are provided on a main surface 210a on the second liquid crystal 230 side of the second TFT substrate 210. The common wirings supply common potential to the common electrodes CE that apply voltage to the second liquid crystal 230. The signal wirings DL supply voltage, via the switching elements 240, to pixel electrodes 250 that apply voltage to the second liquid crystal 230. The scan wirings GL supply voltage for causing the switching elements 240 to operate. The third polarizing plate 232 is provided on a main surface 210b on the side opposite the main surface 210a of the second TFT substrate 210.

In the present embodiment, the scan wirings GL form a hereinafter described first light blocking pattern 260, and the signal wirings DL form a second light blocking pattern 270. Configurations of the scan wirings GL, the signal wirings DL, the second main pixels 202 (the switching elements 240, the common electrodes CE, and the pixel electrodes 250), and the like are described later.

The second counter substrate 220 faces the second TFT substrate 210, and is adhered to the second TFT substrate 210 by a seal material 238. In one example, the second counter substrate 220 is implemented as a glass substrate. An alignment film (not illustrated) for aligning the second liquid crystal 230 is provided on a main surface 220a on the second liquid crystal 230 side of the second counter substrate 220. The adhesive layer 150 is provided on a main surface 220b on the side opposite the main surface 220a of the second counter substrate 220. The second counter substrate 220 is adhered to the first liquid crystal display panel 100 (the first polarizing plate 132) via the adhesive layer 150.

The second liquid crystal 230 is sandwiched between the second TFT substrate 210 and the second counter substrate 220. The second liquid crystal 230 is implemented as a positive nematic liquid crystal. The second liquid crystal 230 is initially aligned in the Y direction by the alignment film. The second liquid crystal 230 rotates in-plane parallel to the main surface 210a of the second TFT substrate 210 due to voltage being applied.

The third polarizing plate 232 is provided on the main surface 210b of the second TFT substrate 210. The transmission axis of the third polarizing plate 232 is arranged parallel to the alignment direction of the second liquid crystal 230. Note that the transmission axis of the third polarizing plate 232 and the transmission axis of the first polarizing plate 132 (a polarizing plate on the light emission side of the second liquid crystal display panel 200) of the first liquid crystal display panel 100 are orthogonal to each other, and the second liquid crystal display panel 200 operates in a normally black mode.

The second driver circuit 236 is provided on the main surface 210a of the second TFT substrate 210. The second driver circuit 236 supplies, on the basis of a monochrome signal supplied from the display controller 400, voltage to the scan wirings GL, the signal wirings DL, and the common wirings.

The scan wirings GL, the signal wirings DL, the first light blocking pattern 260, and the second light blocking pattern 270 are described while referencing FIGS. 4 to 6.

The scan wirings GL and the first light blocking pattern 260 are described. The scan wirings GL have light blocking properties. The scan wirings GL are formed from a metal (aluminum (Al), molybdenum (Mo), or the like). As illustrated in FIGS. 4 and 5, the scan wirings GL extend in the X direction and are arranged in the Y direction. Additionally, a pair of the scan wirings GL that are adjacent to each other form the first light blocking pattern 260 extending in the X direction and having light blocking properties. The first light blocking pattern 260 is repeatedly arranged in the Y direction. Here, the term “light blocking properties” means blocking at least a portion of the light emitted from the backlight 300. In the present embodiment, the X direction corresponds to a predetermined direction of the first light blocking pattern 260 (the scan wirings GL).

As illustrated in FIG. 5, one scan wiring GL (hereinafter also referred to as “first light blocking line 262”) of the pair of scan wirings GL that are adjacent to each other includes a first incline 262a, a second incline 262b, and a first flat section 262c. The first incline 262a is inclined, at an acute angle, in the counterclockwise direction with respect to the +X direction, and the second incline 262b is inclined, at an acute angle, in the direction opposite the first incline 262a (the clockwise direction) with respect to the +X direction. The first flat section 262c extends parallel to the X direction, and connects the first incline 262a and the second incline 262b to each other.

The other scan wiring GL (hereinafter also referred to as “second light blocking line 264”) of the pair of scan wirings GL that are adjacent to each other is line-symmetrical, with respect to the X direction, to the one scan wiring GL (the first light blocking line 262), and includes a third incline 264a, a fourth incline 264b, and a second flat section 264c. The third incline 264a opposes the first incline 262a of the first light blocking line 262, and is inclined, at an acute angle, in the clockwise direction with respect to the +X direction. The fourth incline 264b opposes the second incline 262b of the first light blocking line 262, and is inclined, at an acute angle, in the direction opposite the third incline 264a (the counterclockwise direction) with respect to the +X direction. The second flat section 264c extends parallel to the X direction, opposes the first flat section 262c of the first light blocking line 262, and connects the third incline 264a and the fourth incline 264b to each other.

In the present embodiment, the first light blocking line 262 includes the first incline 262a that is inclined, at an acute angle, in the counterclockwise direction with respect to the +X direction, and the second incline 262b that is inclined, at an acute angle, in the direction opposite the first incline 262a with respect to the +X direction, and the first light blocking line 262 and the second light blocking line 264 adjacent to the first light blocking line 262 have a line-symmetrical relationship with respect to the X direction. Accordingly, as illustrated in FIG. 5, a spacing (spacing L1) between the first light blocking line 262 and the second light blocking line 264 continuously changes between the first incline 262a of the first light blocking line 262 and the third incline 264a of the second light blocking line 264. Additionally a spacing (spacing L2) between the first light blocking line 262 and the second light blocking line 264 also continuously changes between the second incline 262b of the first light blocking line 262 and the fourth incline 264b of the second light blocking line 264. Furthermore, spacings (spacing L3 and spacing L4) between the first flat section 262c of the first light blocking line 262 and the second flat section 264c of the second light blocking line 264 also change (spacing L3 and spacing L4). Due to these configurations, even when the second liquid crystal display panel 200 and the first liquid crystal display panel 100 overlap, spatial frequency interference between the second liquid crystal display panel 200 and the first liquid crystal display panel 100 can be suppressed and, as such, moiré of the liquid crystal display device 10 can be suppressed.

Next, the signal wirings DL and the second light blocking pattern 270 are described. As with the scan wirings GL, the signal wirings DL have light blocking properties, and are formed from a metal (aluminum (AL), molybdenum (Mo), or the like). As illustrated in FIGS. 4 and 5, the signal wirings DL extend in the Y direction and are arranged in the X direction. Additionally, a pair of the signal wirings DL that are adjacent to each other form the second light blocking pattern 270 extending in the Y direction and having light blocking properties. In the present embodiment, the Y direction corresponds to a predetermined direction of the second light blocking pattern 270 (the signal wirings DL).

As illustrated in FIG. 5, one signal wiring DL (hereinafter also referred to as “third light blocking line 272”) of the pair of signal wirings DL that are adjacent to each other includes a fifth incline 272a and a sixth incline 272b. The fifth incline 272a is inclined, at an acute angle, in the counterclockwise direction with respect to the +Y direction. The sixth incline 272b is inclined, at an acute angle, in the direction opposite the fifth incline 272a (the clockwise direction) with respect to the +Y direction.

The other signal wiring DL (hereinafter also referred to as “fourth light blocking line 274”) of the pair of signal wirings DL that are adjacent to each other is line-symmetrical, with respect to the Y direction, to the one signal wiring DL (the third light blocking line 272), and includes a seventh incline 274a and an eighth incline 274b. The seventh incline 274a opposes the fifth incline 272a of the third light blocking line 272, and is inclined, at an acute angle, in the clockwise direction with respect to the +Y direction. The eighth incline 274b opposes the sixth incline 272b of the third light blocking line 272, and is inclined, at an acute angle, in the direction opposite the seventh incline 274a (the counterclockwise direction) with respect to the +Y direction. Note that the third light blocking line 272 and the fourth light blocking line 274 of the second light blocking pattern 270 respectively correspond to a first light blocking line and a second light blocking line of a light blocking pattern, and the fifth incline 272a and the sixth incline 272b of the third light blocking line 272 respectively correspond to a first incline and a second incline of the first light blocking line.

In the present embodiment, the third light blocking line 272 includes the fifth incline 272a that is inclined, at an acute angle, in the counterclockwise direction with respect to the +Y direction, and the sixth incline 272b that is inclined, at an acute angle, in the direction opposite the fifth incline 272a with respect to the +Y direction, and the third light blocking line 272 and the fourth light blocking line 274 adjacent to the third light blocking line 272 have a line-symmetrical relationship with respect to the Y direction. Accordingly, as illustrated in FIG. 5, a spacing L5 between the third light blocking line 272 and the fourth light blocking line 274 continuously changes. Due to these configurations, even when the second liquid crystal display panel 200 and the first liquid crystal display panel 100 overlap, spatial frequency interference between the second liquid crystal display panel 200 and the first liquid crystal display panel 100 can be suppressed and, as such, moiré of the liquid crystal display device 10 can be suppressed.

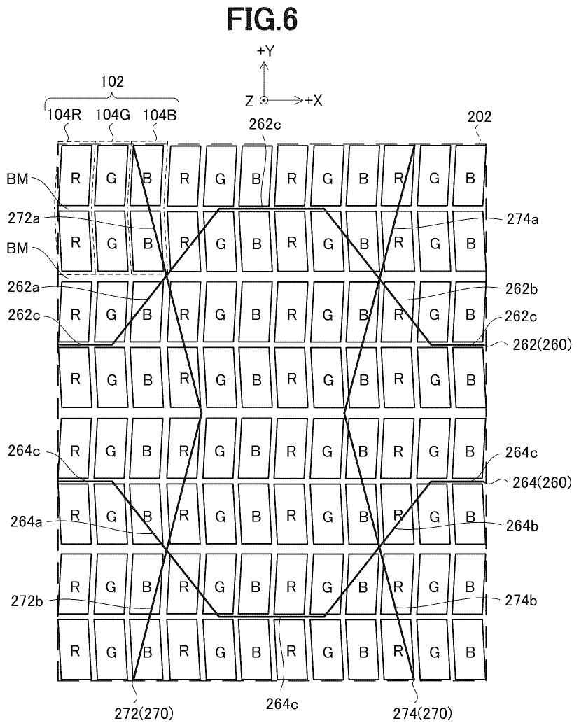

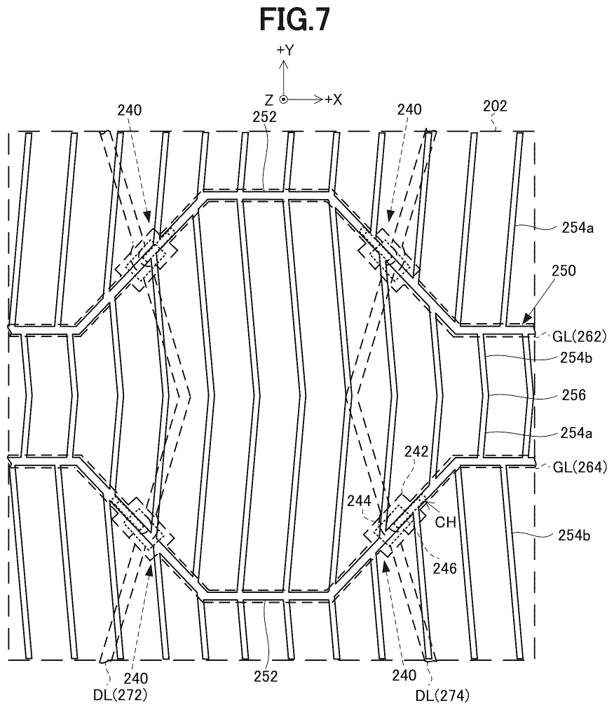

Next, the overlapping of the first light blocking pattern 260 and the second light blocking pattern 270 with the first main pixels 102 of the first liquid crystal display panel 100 is described while referencing FIG. 6. FIG. 6 illustrates the first light blocking pattern 260 (the scan wirings GL), the second light blocking pattern 270 (the signal wirings DL), and the first main pixels 102 of the first liquid crystal display panel 100 corresponding to one second main pixel 202 of the second liquid crystal display panel 200. In the present embodiment, as described later, one second main pixel 202 of the second liquid crystal display panel 200 is driven by voltage (signals) from a pair of adjacent scan wirings GL and a pair of adjacent signal wirings DL.

As illustrated in FIG. 6, in the first light blocking pattern 260 extending in the X direction, the first incline 262a and the second incline 262b of the first light blocking line 262 and the third incline 264a and the fourth incline 264b of the second light blocking line 264 are inclined across the plurality of subpixels 104 (104R, 104G, 104B) of different colors of the first liquid crystal display panel 100. Due to this, the brightness of the subpixels 104 that the first light blocking pattern 260 overlaps slightly decreases, and the first main pixels 102 including the subpixels 104 that the first light blocking pattern 260 overlaps present a color that slightly differs from the color intended to be displayed. However, since the subpixels 104 in which a similar degree of reduction in brightness occurs are positioned in close proximity, the brightness of the subpixels 104 is averaged with respect to the observer observing the liquid crystal display device 10, and the observer recognizes the brightnesses of the plurality of subpixels 104 having the reduced brightness as the same brightness gradation. Accordingly, in terms of the entire display of the liquid crystal display device 10, it is possible to suppress recognition of color moiré by the observer. Note that, the first flat section 262c of the first light blocking line 262 and the second flat section 264c of the second light blocking line 264 overlap the black matrix BM of the first liquid crystal display panel 100.

In the second light blocking pattern 270 extending in the Y direction, the fifth incline 272a and the sixth incline 272b of the third light blocking line 272 and the seventh incline 274a and the eighth incline 274b of the fourth light blocking line 274 are inclined across the plurality of subpixels 104 (104R, 104B) of different colors of the first liquid crystal display panel 100. Due to this, as with the first light blocking pattern 260, the first main pixels 102 including the subpixels 104 that the second light blocking pattern 270 overlaps present a color that slightly differs from the color intended to be displayed. However, the color presented by the first main pixels 102 including the subpixels 104 that the second light blocking pattern 270 overlaps and the color presented by the first main pixels 102 positioned in the proximity of the first main pixels 102 including the subpixels 104 that the second light blocking pattern 270 overlaps are recognized as different colors by the observer, and the saturation of mixed colors also declines. Accordingly, in terms of the entire display of the liquid crystal display device 10, it is possible to suppress recognition of color moiré by the observer.

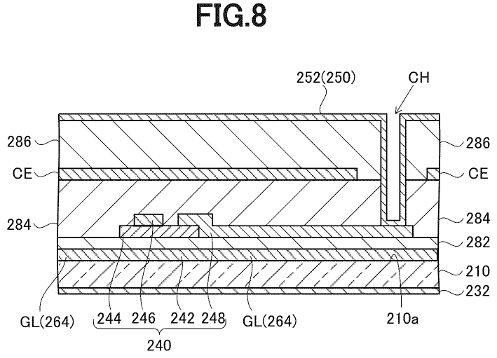

Next, the scan wirings GL (the first light blocking line 262 and the second light blocking line 264), the signal wirings DL (the third light blocking line 272 and fourth light blocking line 274), the switching elements 240, the pixel electrodes 250 and the common electrodes CE of the second main pixel 202 are described while referencing FIGS. 7 to 14. FIG. 7 is a plan view illustrating the scan wirings GL, the signal wirings DL, the switching elements 240, and the pixel electrode 250. FIG. 8 is a cross-sectional view of the switching element 240 and the contact hole CH. Note that, to facilitate comprehension, the common electrodes CE are omitted from FIG. 7.

In the present embodiment, as illustrated in FIG. 7, one second main pixel 202 includes four switching elements 240 and one pixel electrode 250. One second main pixel 202 is driven by voltage (signals) from the pair of adjacent scan wirings GL (the first light blocking line 262 and the second light blocking line 264) and the pair of adjacent signal wirings DL (the third light blocking line 272 and the fourth light blocking line 274).

As illustrated in FIG. 8, the scan wirings GL (the first light blocking line 262 and the second light blocking line 264) are formed on the main surface 210a of the second TFT substrate 210, and are covered by a first insulating layer 282. The signal wirings DL (the third light blocking line 272 and the fourth light blocking line 274) are formed on the first insulating layer 282, and are covered by a second insulating layer 284.

As illustrated in FIG. 8, the common electrodes CE are formed on the second insulating layer 284. In one example, the common electrodes CE are formed from indium tin oxide (ITO). The common electrodes CE are covered by a third insulating layer 286.

The four switching elements 240 are respectively provided at intersections of the scan wirings GL and the signal wirings DL. As illustrated in FIGS. 7 and 8, each of the switching elements 240 includes a gate electrode 242, a semiconductor layer 244, a source electrode 246, and a drain electrode 248. In one example, the switching elements 240 are implemented as TFT elements.

The gate electrode 242 is formed, integrally with the scan wiring GL, on the main surface 210a of the second TFT substrate 210. As with the scan wirings GL, the gate electrode 242 is covered by the first insulating layer 282. The semiconductor layer 244 is provided, via the first insulating layer 282, in an island manner above the gate electrode 242. In one example, the semiconductor layer 244 is formed from amorphous silicon. The source electrode 246 is formed integrally with the signal wiring DL. The drain electrode 248 extends along the scan wiring GL from on the semiconductor layer 244, and connects to the pixel electrode 250. As illustrated in FIG. 8, the drain electrode 248 is connected to the pixel electrode 250 via the contact hole CH that penetrates the third insulating layer 286 and the second insulating layer 284. The gate electrode 242, the source electrode 246, and the drain electrode 248 are formed from a metal such as aluminum (Al), molybdenum (Mo), or the like. Additionally, as illustrated in FIG. 8, the semiconductor layer 244, the source electrode 246, and the drain electrode 248 are covered by the second insulating layer 284.

As illustrated in FIG. 8, the first insulating layer 282 covers the scan wirings GL, and the gate electrode 242 of the switching element 240. The second insulating layer 284 covers the semiconductor layer 244, the source electrode 246, and the drain electrode 248 of the switching element 240, and the first insulating layer 282. The third insulating layer 286 covers the common electrodes CE and the second insulating layer 284. The first insulating layer 282, the second insulating layer 284, and the third insulating layer 286 are formed from silicon nitride (SiNₓ), silicon oxide (SiOₓ), or the like.

As illustrated in FIG. 7, the pixel electrode 250 is connected to the four switching elements 240 (the drain electrodes 248). The pixel electrode 250 has a comb-teeth shape. As illustrated in FIG. 8, the pixel electrode 250 is formed on the third insulating layer 286. In one example, the pixel electrode 250 is formed from ITO.

The pixel electrode 250 has two connectors 252, a plurality of first tooth portions 254a, and a plurality of second tooth portions 254b. In the following, the first tooth portions 254a and the second tooth portions 254b are sometimes referred to collectively as “tooth portions 254.”

One of the two connectors 252 extends in the X direction, bends in a manner similar to the first light blocking line 262, and overlaps the first light blocking line 262. The other of the two connectors 252 extends in the X direction, bends in a manner similar to the second light blocking line 264, and overlaps the second light blocking line 264.

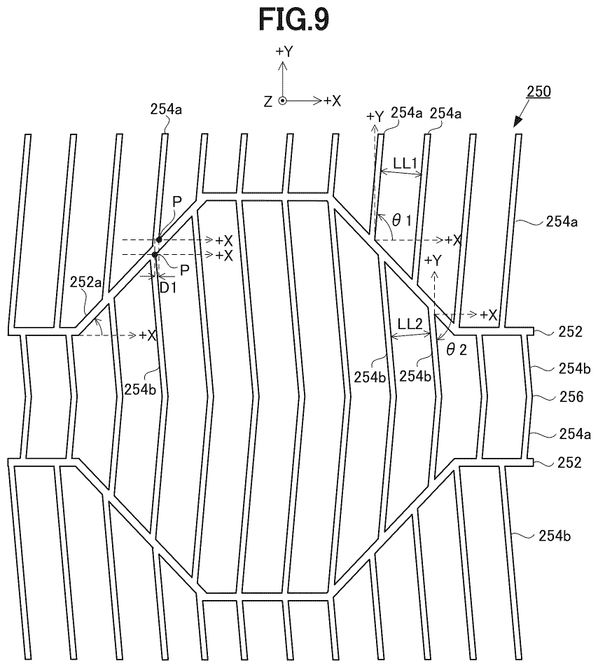

The first tooth portions 254a and the second tooth portions 254b branch from the connector 252 (i.e., directly connecting to the connector 252), extend in the direction opposite to each other (+Y direction and −Y direction) across the connector 252, and are inclined, at an acute angle, in the direction opposite to each other with respect to the X direction (the predetermined direction). Specifically, as illustrated in FIG. 9, the first tooth portions 254a extend in +Y direction and are inclined, at an acute angle (angle of inclination θ1), in the counterclockwise direction with respect to the +X direction. The second tooth portions 254b extend in the −Y direction and are inclined, at an acute angle (angle of inclination θ2), in the clockwise direction with respect to the +X direction. In the present embodiment, as illustrated in FIGS. 7 and 9, the second tooth portions 254b extending from the connector 252 overlapping the first light blocking line 262 and the first tooth portions 254a extending from the connector 252 overlapping the second light blocking line 264 are connected to each other. As a result, bent portions 256 at which the tooth portions 254 are bent are formed at the center portion of the second main pixel 202.

In the present embodiment, by shifting a position P at which the first tooth portion 254a is branched from the connector 252 from a position P at which the second tooth portion 254b is branched from the connector 252 at the portion 252a of the connector 252 that is inclined with respect to the X direction (a distance D1 with respect to the X direction in the example of FIG. 9), the connector 252 is made to overlap with the first light blocking line 262 or the second light blocking line 264, a distance LL1 between the first tooth portions 254a is made to be equal to a distance LL2 between the second tooth portions 254b, and the angle of inclination θ1 of the first tooth portions 254a is made to be equal to the angle of inclination θ2 of the second tooth portions 254b. The distance LL1 and the distance LL2 are made to be equal to each other, and the angle of inclination θ1 and the angle of inclination θ2 are made to be equal to each other. As such, an electric field E to be applied on the second liquid crystal 230 by the first tooth portions 254a and an electric field E to be applied on the second liquid crystal 230 by the second tooth portions 254b can be made equal to each other, and the optical characteristics within the second main pixel 202 can be uniformed. The distance LL1 refers to the shortest distance between opposing side surfaces of adjacent first tooth portions 254a, and the distance LL2 refers to the shortest distance between opposing side surfaces of adjacent second tooth portions 254b.

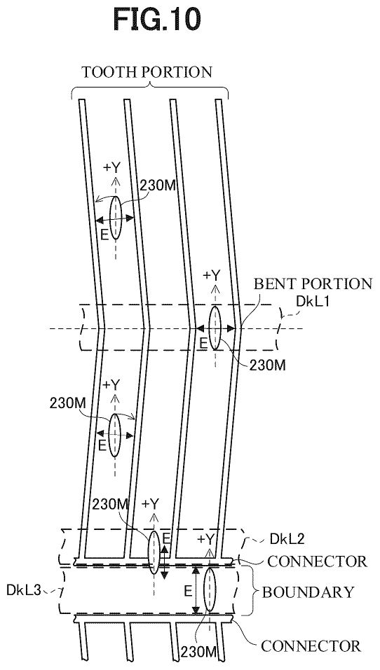

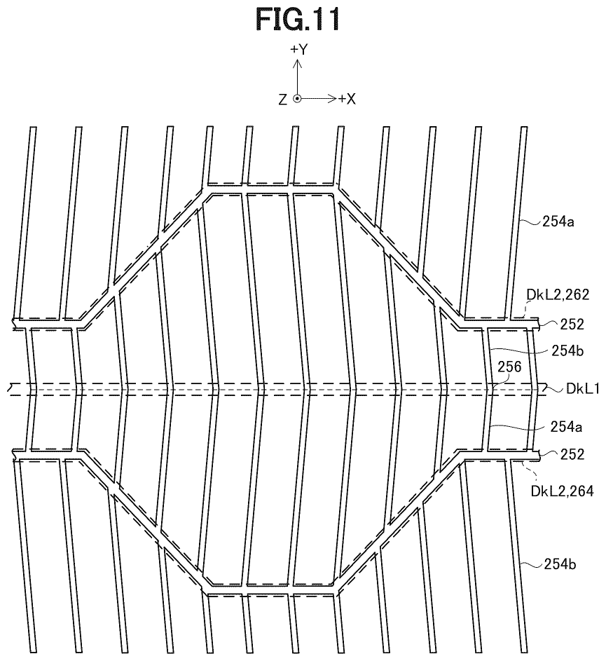

Here, the dark lines generated when voltage is applied to the second liquid crystal 230 using a pixel electrode having a comb-teeth shape are described while referencing FIG. 10. As illustrated in FIG. 10, when voltage is applied, in a normally black mode, to the second liquid crystal 230 aligned in the Y direction by the pixel electrode having tooth portions that are bent and extend in the Y direction, the electric field E in the X direction acts on liquid crystal molecules 230M at the bent portions of the tooth portions and, as such, the liquid crystal molecules 230M do not rotate. As a result, a dark line DkL1, extending in the X direction, due to the bent portions is generated. Additionally, the electric field E in the Y direction acts on the liquid crystal molecules 230M in the vicinity of the connector connecting tooth portions. As such, a dark line DkL2, extending in the X direction, due to the connector is generated. Additionally, the electric field E in the Y direction acts on the liquid crystal molecules 230M at the boundary of the adjacent pixel electrodes. As such. a dark line DkL3, extending in the X direction, due to the boundary is generated.

In the present embodiment, as illustrated in FIG. 11, when voltage is applied on the second liquid crystal 230, one dark line DkL1, extending in the X direction, due to the bent portions 256 is generated within the second main pixel 202. Additionally, two dark lines DkL2, extending in the X direction, due to the connectors 252 are generated. Furthermore, the first light blocking line 262 and the second light blocking line 264 also become dark lines extending in the X direction. As described above, the connectors 252 of the pixel electrodes 250 overlap the first light blocking line 262 or the second light blocking line 264. As such, the first light blocking line 262 and the dark line DkL2, extending in the X direction, due to the connector 252 overlapping the first light blocking line 262 are implemented as one dark line extending in the X direction. Additionally, the second light blocking line 264 and the dark line DkL2, extending in the X direction, due to the connector 252 overlapping the second light blocking line 264 are implemented as one dark line extending in the X direction. Therefore, in the pixel electrode 250 of the present embodiment, only three dark lines are generated as dark lines extending in the X direction within the second main pixel 202. The three dark lines are the dark line DkL1 due to the bent portions 256, the dark line along which the dark line DkL2 due to the connector 252 overlaps the first light blocking line 262, and the dark line along which the dark line DkL2 due to the connector 252 overlaps the second light blocking line 264.

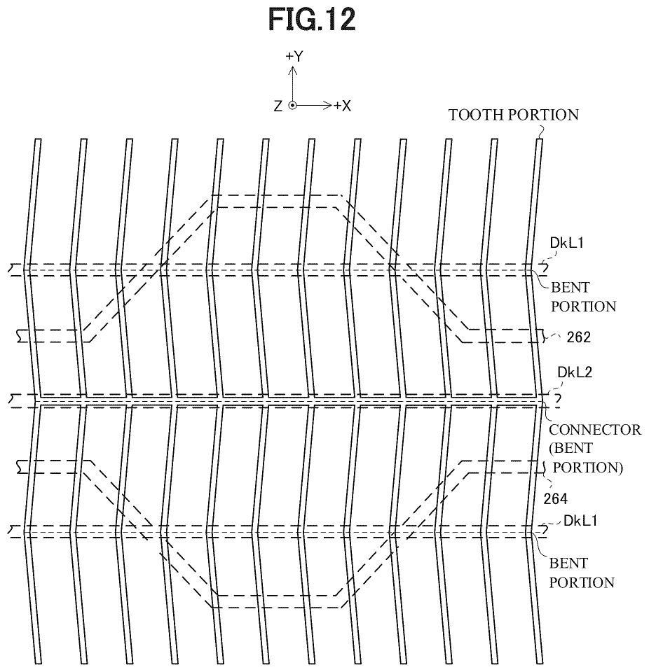

Meanwhile, in a case where a pixel electrode of which bent tooth portions branch from the connectors in the +Y direction and −Y direction and connectors overlap neither the first light blocking line nor the second light blocking line is applied in the present embodiment (hereinafter referred to as “Comparative Example 1”) instead of the pixel electrode 250, five dark lines are generated as illustrated in FIG. 12. The five dark lines are two dark lines DkL1, extending in the X direction, due to the bent portions 256, one dark line DkL2, extending in the X direction, due to the connector 252, the first light blocking line 262, and the second light blocking line 264. Note that the switching elements 240 are omitted from FIGS. 11 and 12. In some of the drawings referred in the following as well, the switching elements 240 may be omitted.

As described above, in the present embodiment, the connectors 252 of the pixel electrode 250 overlap the first light blocking line 262 or the second light blocking line 264. As such, the number of dark lines generated when voltage is applied to the second liquid crystal 230 can be reduced.

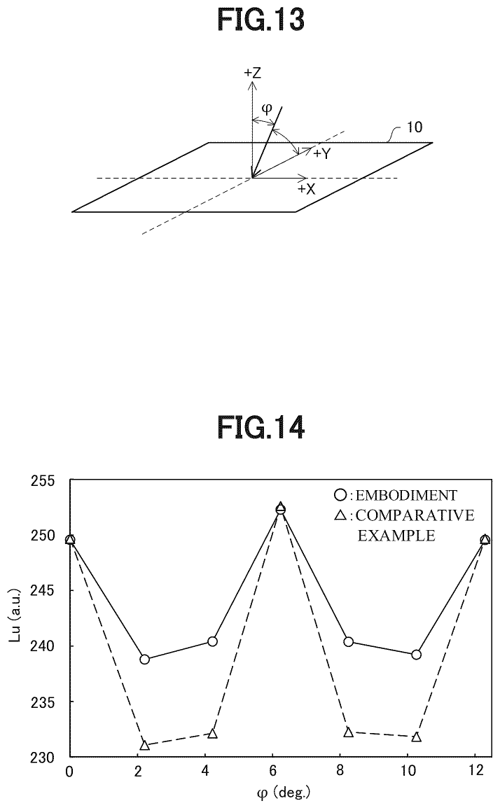

Next, a relationship between the angle φ of the viewing direction in which an observer views the liquid crystal display device 10 and brightness Lu of the liquid crystal display device 10 in a region corresponding to one second main pixel 202 in a state in which a white color is displayed is described. As illustrated in FIG. 13, the viewing direction is a direction toward the +Y side from the front, and the angle φ is an angle relative to the +Z direction.

FIG. 14 illustrates relationships between the angle φ of the viewing direction and brightness Lu of the liquid crystal display device 10 and brightness Lu according to Comparative Example 1 in a state in which a white color is displayed, obtained by simulation. The brightness Lu in Comparative Example 1 is brightness Lu of a liquid crystal display device including the pixel electrode of Comparative Example 1 described above instead of the pixel electrode 250. As illustrated in FIG. 14, in the liquid crystal display device 10, the change in the brightness Lu due to the angle φ of the viewing direction is small, and thus, moiré can be suppressed. That is, the liquid crystal display device 10 can reduce the number of dark lines generated when voltage is applied to the second liquid crystal 230, and thus, moiré can be suppressed.

### Backlight

As illustrated in FIG. 1, the backlight 300 is arranged on the back side surface (the −Z side) of the second liquid crystal display panel 200. In one example, the backlight 300 is implemented as a direct backlight. The backlight 300 includes a white light emitting diode (LED), a reflective sheet, a diffusion sheet, and the like (all not illustrated in the drawings).

### Display Controller

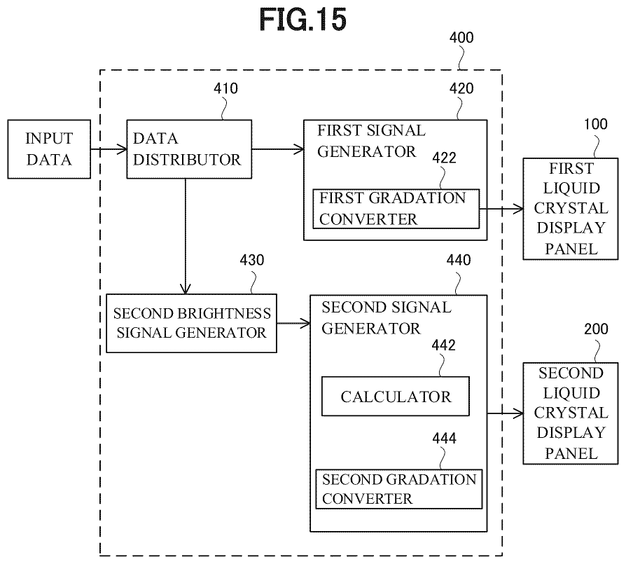

The display controller 400 controls the displays of the first liquid crystal display panel 100 and the second liquid crystal display panel 200. As illustrated in FIG. 15, the display controller 400 includes a data distributor 410, a first signal generator 420, a second brightness signal generator 430, and a second signal generator 440.

The data distributor 410 distributes input data (data expressing display elements) to the first signal generator 420 and the second brightness signal generator 430.

The first signal generator 420 generates, from the input data distributed by the data distributor 410, a color display element to be displayed on the first liquid crystal display panel 100. Specifically, a first gradation converter 422 of the first signal generator 420 performs gradation conversion for converting the distributed input data to color data having brightness-gradation characteristics suited to the first liquid crystal display panel 100. In one example, a lookup table in which input/output relationships are preset is used in the conversion of the data. The first signal generator 420 sends a color signal expressing the generated color display element to the first driver circuit 136 of the first liquid crystal display panel 100.

The second brightness signal generator 430 generates, from the input data distributed by the data distributor 410, a brightness signal for generating a monochrome display element to be displayed on the second liquid crystal display panel 200. In one example, the second brightness signal generator 430 calculates a brightness level of one second main pixel 202 of the second liquid crystal display panel 200 from the average value, the frequent value, the minimum value, the maximum value, or the like of red gradation values, green gradation values, and blue gradation values in the 16 first main pixels 102 of the first liquid crystal display panel 100 on which the light transmitted the one second main pixel 202 of the second liquid crystal display panel 200 is incident. The calculated brightness level may be a gradation value. The second brightness signal generator 430 sends a brightness signal expressing the calculated brightness level to the second signal generator 440.

The second signal generator 440 generates, on the basis of the brightness signal sent from the second brightness signal generator 430, the monochrome display element to be displayed on the second liquid crystal display panel 200. In one example, the second signal generator 440 generates a monochrome display element that has been subjected to averaging processing and gradation conversion. Specifically, in one example, a calculator 442 of the second signal generator 440 uses a weighted average based on the distance from a target second main pixel 202 to average the brightness levels of the second main pixels 202 located within a predetermined distance from the target second main pixel 202. As a result, the second signal generator 440 can generate a monochrome image that has blurred edges. Furthermore, a second gradation converter 444 of the second signal generator 440 generates monochrome data having brightness-gradation characteristics suited to the second liquid crystal display panel 200. The configuration of the second gradation converter 444 is the same as that of the first gradation converter 422 of the first signal generator 420.

The monochrome signal sent to the second liquid crystal display panel 200 is delayed, by the calculation of the brightness level, the averaging processing, and the like executed by the second brightness signal generator 430, with respect to the color signal sent to the first liquid crystal display panel 100. As such, the display controller 400 includes a non-illustrated synchronization circuit for synchronizing the outputting of the monochrome signal and the color signal. Due to this synchronization circuit, the monochrome display element corresponding to the color display element of the first liquid crystal display panel 100 is displayed on the second liquid crystal display panel 200 and, as such, an appropriate color display element is displayed on the liquid crystal display device 10.

The display controller 400 is configured from a central processing unit (CPU), a memory, and the like. In one example, the CPU executes programs stored in the memory to realize the functions of the display controller 400.

As described above, the connectors 252 of the pixel electrode 250 of the second liquid crystal display panel 200 overlap the first light blocking line 262 or the second light blocking line 264 of the second liquid crystal display panel 200. As such, the number of dark lines generated within the second main pixel 202 of the second liquid crystal display panel 200 when voltage is applied to the second liquid crystal 230 can be reduced, and thus, moiré of the liquid crystal display device 10 can be suppressed.

Additionally, the first light blocking pattern 260 of the second liquid crystal display panel 200 is formed from the first light blocking line 262 including the first incline 262a, the second incline 262b, and the first flat section 262c, and the second light blocking line 264 that is line-symmetrical, with respect to the X direction, to the first light blocking line 262. As a result, moiré of the liquid crystal display device 10 can be suppressed. Furthermore, the second light blocking pattern 270 of the second liquid crystal display panel 200 is formed from the third light blocking line 272 including the fifth incline 272a and the sixth incline 272b, and the fourth light blocking line 274 that is line-symmetrical, with respect to the Y direction, to the third light blocking line 272. As a result, moiré of the liquid crystal display device 10 can be suppressed. Furthermore, the occurrence of color moiré can also be suppressed.

Additionally, the number of dark lines generated within the second main pixel 202 of the second liquid crystal display panel 200 when voltage is applied to the second liquid crystal 230 can be reduced. As such, the aperture ratio (transmittance) of the second main pixel 202 in a state in which voltage is applied to the second liquid crystal 230 can be increased. For example, the aperture ratio of the second main pixel 202 in a state in which voltage is applied to the second liquid crystal 230 is 95.4%. For example, the aperture ratio of the second main pixel 202 including the pixel electrode of Comparative Example 1 described above, instead of the pixel electrode 250, in a state in which voltage is applied to the second liquid crystal 230 is 93.9%.

Furthermore, as described above, moiré of the liquid crystal display device 10 can be suppressed by the pixel electrode 250, the first light blocking pattern 260, and the second light blocking pattern 270. As such, the transmittance of the liquid crystal display device 10 can be increased by use of an adhesive layer 150 having a low haze value (high transmittance) as the adhesive layer 150 adhering the first liquid crystal display panel 100 and the second liquid crystal display panel 200 to each other.

### Embodiment 2

In Embodiment 1, the second main pixel 202 has one pixel electrode 250. The second main pixel 202 may have a plurality of pixel electrodes 250.

Here, the pixel electrodes 250 of the second liquid crystal display panel 200 of the present embodiment are described. The other configurations of the liquid crystal display device 10 of the present embodiment are the same as the configurations of the liquid crystal display device 10 of Embodiment 1.

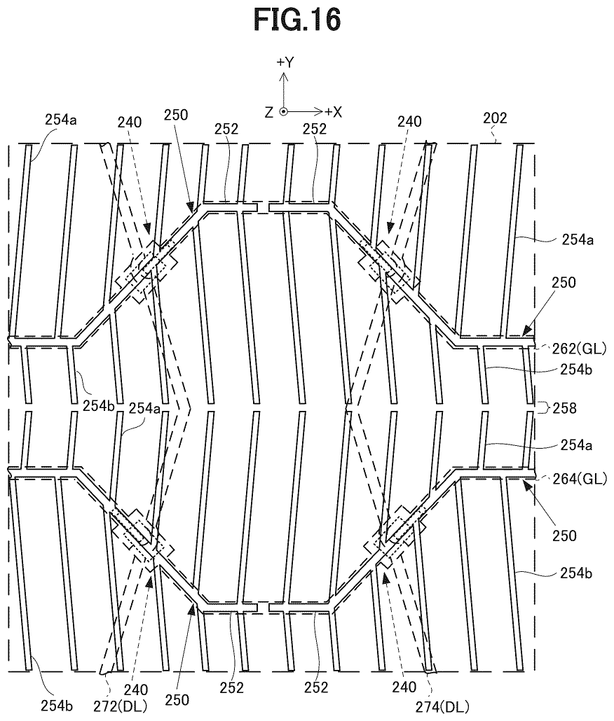

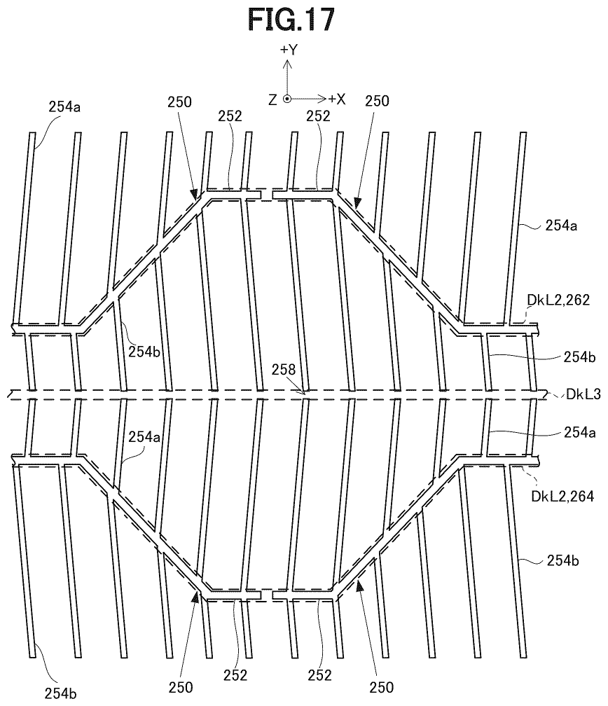

In the present embodiment, as illustrated in FIG. 16, one second main pixel 202 of the second liquid crystal display panel 200 has four pixel electrodes 250. As with the pixel electrode 250 of Embodiment 1, each pixel electrode 250 has a connector 252, first tooth portions 254a, and second tooth portions 254b. The connector 252 overlaps the first light blocking line 262 or the second light blocking line 264. The first tooth portions 254a and the second tooth portions 254b branch from the connector 252, extend in the direction opposite to each other across the connector 252, and are inclined, at an acute angle, in the direction opposite to each other with respect to the X direction.

The four pixel electrodes 250 are arranged in two rows and two columns, in the X direction and the Y direction, and the one pixel electrode 250 connects to the one switching elements 240. In the present embodiment, the pixel electrodes 250 are arranged in two rows and two columns. As such, instead of the bent portions 256 in Embodiment 1, a boundary 258, extending in the X direction, of the pixel electrodes 250 are formed.

In the present embodiment, as illustrated in FIG. 17, when voltage is applied on the second liquid crystal 230, one dark line DkL3, extending in the X direction, due to the boundary 258 is generated within the second main pixel 202. Furthermore, as in Embodiment 1, two dark lines DkL2, extending in the X direction, due to the connectors 252, a dark line, extending in the X direction, due to the first light blocking line 262, and a dark line, extending in the X direction, due to the second light blocking line 264 are generated. As in Embodiment 1, the connectors 252 of the pixel electrodes 250 overlap the first light blocking line 262 or the second light blocking line 264. As such, the dark line due to the first light blocking line 262 and the dark line DkL2, extending in the X direction, due to the connectors 252 overlapping the first light blocking line 262 are implemented as one dark line extending in the X direction. Additionally, the dark line due to the second light blocking line 264 and the dark line DkL2, extending in the X direction, due to the connectors 252 overlapping the second light blocking line 264 are implemented as one dark line extending in the X direction. Therefore, in the present embodiment as well, only three dark lines are generated as dark lines extending in the X direction within the second main pixel 202.

As described above, in the present embodiment as well, the connectors 252 of the pixel electrodes 250 overlap the first light blocking line 262 or the second light blocking line 264. As such, the number of dark lines generated within the second main pixel 202 of the second liquid crystal display panel 200 when voltage is applied to the second liquid crystal 230 can be reduced, and thus, moiré of the liquid crystal display device 10 can be suppressed.

In the present embodiment as well, moiré of the liquid crystal display device 10 can be suppressed by the first light blocking pattern 260 and the second light blocking pattern 270. Furthermore, as in Embodiment 1, the aperture ratio of the second main pixel 202 and the transmittance of the liquid crystal display device 10 can be increased.

### Embodiment 3

In Embodiment 2, the connectors 252 of the pixel electrodes 250 overlap the first light blocking line 262 or the second light blocking line 264. The connectors 252 of the pixel electrodes 250 may overlap the third light blocking line 272 or the fourth light blocking line 274.

Here, the pixel electrodes 250 of the second liquid crystal display panel 200 of the present embodiment are described. The other configurations of the liquid crystal display device 10 of the present embodiment are the same as the configurations of the liquid crystal display device 10 of Embodiment 1.

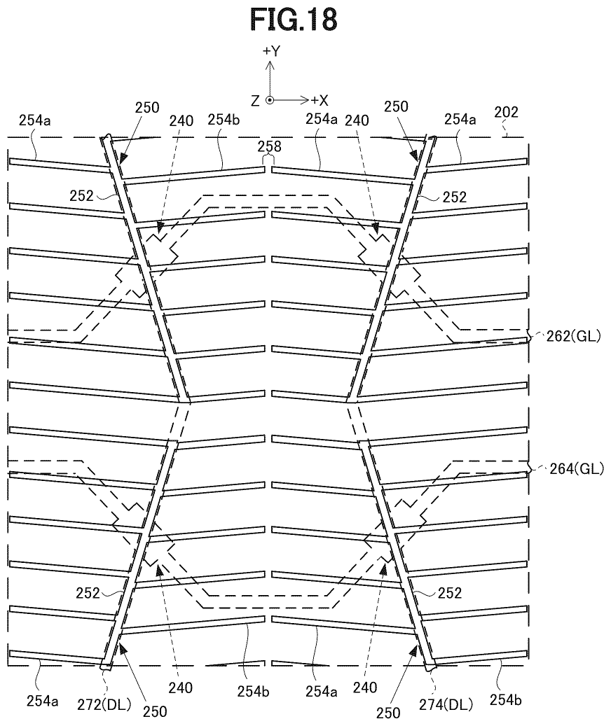

In the present embodiment, as illustrated in FIG. 18, one second main pixel 202 of the second liquid crystal display panel 200 has four pixel electrodes 250. The four pixel electrodes 250 are arranged in two rows and two columns, in the X direction and the Y direction, and the one pixel electrode 250 connects to the one switching elements 240. Each pixel electrode 250 has a connector 252, first tooth portions 254a, and second tooth portions 254b. Note that, to facilitate comprehension, the switching elements 240 are simplified in FIG. 18.

In the present embodiment, the connectors 252 extend in the Y direction, bend in a manner similar to the third light blocking line 272 or the fourth light blocking line 274, and overlap the third light blocking line 272 or the fourth light blocking line 274.

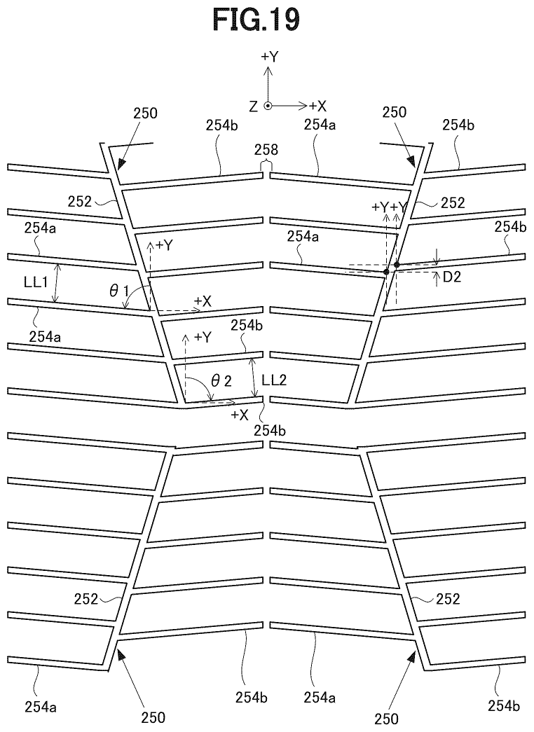

As illustrated in FIG. 19, the first tooth portions 254a and the second tooth portions 254b branch from the connector 252, extend in the direction opposite to each other (+X direction and −X direction) across the connector 252, and are inclined, at an acute angle, in the direction opposite to each other with respect to the Y direction (the predetermined direction). Specifically, the first tooth portions 254a extend in −X direction and are inclined, at an acute angle (angle of inclination θ1), in the clockwise direction with respect to the +Y direction. The second tooth portions 254b extend in the +X direction and are inclined, at an acute angle (angle of inclination θ2), in the counterclockwise direction with respect to the +Y direction. In the present embodiment, the pixel electrodes 250 are arranged in two rows and two columns, the first tooth portions 254a extend in the −X direction, and the second tooth portions 254b extend in the +X direction. As such, a boundary 258, extending in the Y direction, of the pixel electrodes 250 are formed at the center portion of the second main pixel 202.

In the present embodiment, by shifting a position P at which the first tooth portion 254a is branched from the connector 252 from a position P at which the second tooth portion 254b is branched from the connector 252 (distance D2 with respect to the Y direction in the example of FIG. 19), the connector 252 is made to overlap with the third light blocking line 272 or the fourth light blocking line 274, a distance LL1 between the first tooth portions 254a is made to be equal to a distance LL2 between the second tooth portions 254b, and the angle of inclination θ1 of the first tooth portions 254a is made to be equal to the angle of inclination θ2 of the second tooth portions 254b. As a result, as in Embodiment 1, the optical characteristics within the second main pixel 202 can be uniformed.

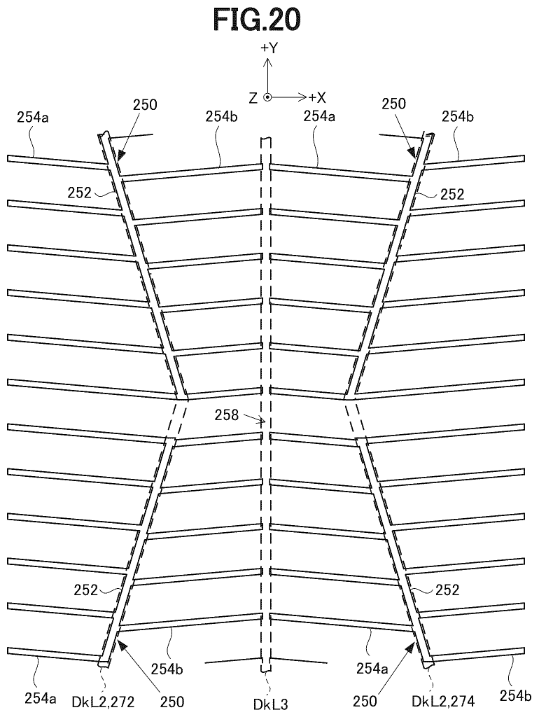

In the present embodiment, as illustrated in FIG. 20, when voltage is applied on the second liquid crystal 230, one dark line DkL3, extending in the Y direction, due to the boundary 258 is generated within the second main pixel 202. Furthermore, two dark lines DkL2, extending in the Y direction, due to the connectors 252, a dark line, extending in the Y direction, due to the third light blocking line 272, and a dark line, extending in the Y direction, due to the fourth light blocking line 274 are generated. However, the connectors 252 of the pixel electrodes 250 overlap the third light blocking line 272 or the fourth light blocking line 274. As such, the dark line due to the third light blocking line 272 and the dark line DkL2, extending in the Y direction, due to the connectors 252 overlapping the third light blocking line 272 are implemented as one dark line extending in the Y direction. The dark line due to the fourth light blocking line 274 and the dark line DkL2, extending in the Y direction, due to the connectors 252 overlapping the fourth light blocking line 274 are implemented as one dark line extending in the Y direction. Therefore, only three dark lines are generated as dark lines extending in the Y direction within the second main pixel 202.

As described above, the connectors 252 of the pixel electrodes 250 overlap the third light blocking line 272 or the fourth light blocking line 274. As such, the number of dark lines generated within the second main pixel 202 of the second liquid crystal display panel 200 when voltage is applied to the second liquid crystal 230 can be reduced, and thus, moiré of the liquid crystal display device 10 can be suppressed.

In the present embodiment as well, moiré of the liquid crystal display device 10 can be suppressed by the first light blocking pattern 260 and the second light blocking pattern 270. Furthermore, as in Embodiment 1, the aperture ratio of the second main pixel 202 and the transmittance of the liquid crystal display device 10 can be increased.

### Embodiment 4

In Embodiment 1 to Embodiment 3, the panel section 50 of the liquid crystal display device 10 includes the first liquid crystal display panel 100 and the second liquid crystal display panel 200. The panel section 50 may include a touch panel 610 instead of the first liquid crystal display panel 100. The touch panel 610 corresponds to the element.

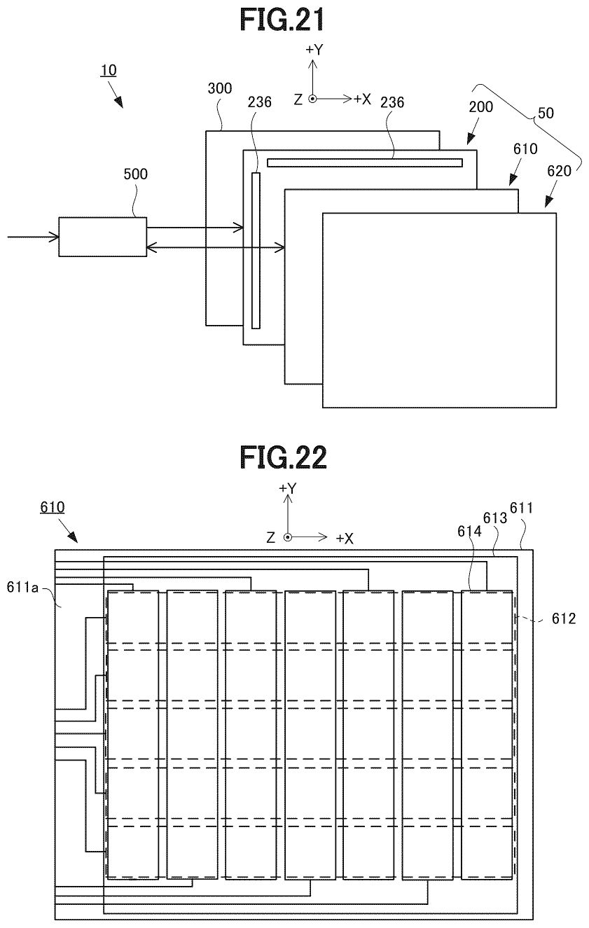

As illustrated in FIG. 21, the liquid crystal display device 10 of the present embodiment includes a panel section 50, a backlight 300, and a controller 500. The panel section 50 includes a second liquid crystal display panel 200, a touch panel 610, and a cover 620. The backlight 300 is a light source that emits light on the second liquid crystal display panel 200. The controller 500 controls the display of the second liquid crystal display panel 200. Additionally, the controller 500 detects a position at which a target (for example, a pen) contacts the touch panel 610, from the capacitance formed between the target and a first electrode 612 and a second electrode 614, which are described later.

The touch panel 610 of the panel section 50 is implemented as a capacitive touch panel. The touch panel 610 is provided on a display surface side (the +Z side) of the second liquid crystal display panel 200 via a non-illustrated adhesive layer.

As illustrated in FIG. 22, the touch panel 610 includes a light transmitting substrate 611, a plurality of first electrodes 612, an insulating layer 613, and a plurality of second electrodes 614.

In one example, the light transmitting substrate 611 of the touch panel 610 is implemented as a glass substrate. The light transmitting substrate 611 includes a main surface 611a.

The first electrodes 612 of the touch panel 610 are provided on the main surface 611a of the light transmitting substrate 611. The first electrode 612 has a rectangular shape, and extends in the X direction. The first electrodes 612 are arranged at equal intervals in the Y direction. Each of the first electrodes 612 is electrically connected to the controller 500 via a non-illustrated wiring.

The insulating layer 613 of the touch panel 610 is provided on the first electrodes 612, and insulates the first electrodes 612 and the second electrodes 614 from each other. In one example, the insulating layer 613 is implemented as a silicon oxide thin film.

The second electrodes 614 of the touch panel 610 are provided on the insulating layer 613. The second electrode 614 has a rectangular shape and extends in the Y direction to intersect the first electrode 612. Each of the second electrodes 614 is electrically connected to the controller 500 via a non-illustrated wiring.

In one example, the first electrodes 612 and the second electrodes 614 are formed from ITO. The first electrodes 612 and the second electrodes 614 form capacitance with the target. The position at which the target contacts is detected from the formed capacitance by the controller 500.

The cover 620 of the panel section 50 is formed of glass in a flat shape. As illustrated in FIG. 21, the cover 620 is positioned on the +Z side of the touch panel 610, and protects the touch panel 610. The cover 620 is adhered to the touch panel 610 via a non-illustrated adhesive layer.

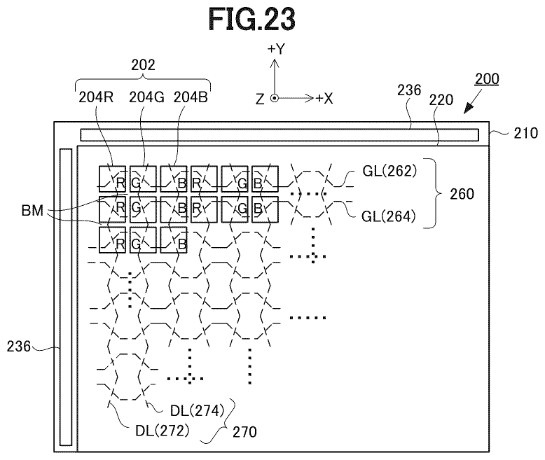

The second liquid crystal display panel 200 of the present embodiment displays a color display element. As illustrated in FIG. 23, the second liquid crystal display panel 200 of the present embodiment includes second main pixels 202 arranged in a matrix. The second main pixel 202 includes a red pixel 204R that transmits red light, a green pixel 204G that transmits green light, and a blue pixel 204B that transmits blue light that are defined by a black matrix BM. In the present embodiment, a color filter (not illustrated) of which the stripe direction is the Y direction, and a black matrix BM are formed on the second counter substrate 220 of the second liquid crystal display panel 200. A polarizing plate on the light emission side is provided on a main surface 220b of the second counter substrate 220. Note that the red pixel 204R, the green pixel 204G, and the blue pixel 204B may be referred to collectively as “subpixels 204.”

The configurations of the scan wirings GL (the first light blocking pattern 260, the first light blocking line 262, the second light blocking line 264), the signal wirings DL (the second light blocking pattern 270, the third light blocking line 272, the fourth light blocking line 274), the pixel electrodes 250, and the like of the second liquid crystal display panel 200 in the present embodiment are the same as the configurations thereof in Embodiment 2. The subpixels 204 in two rows and two columns in the present embodiment correspond to one second main pixel 202 of Embodiment 2. For example, in FIG. 23, two red pixels 204R arranged in the Y direction and two green pixels 204G arranged in the Y direction correspond to one second main pixel 202 of Embodiment 2.

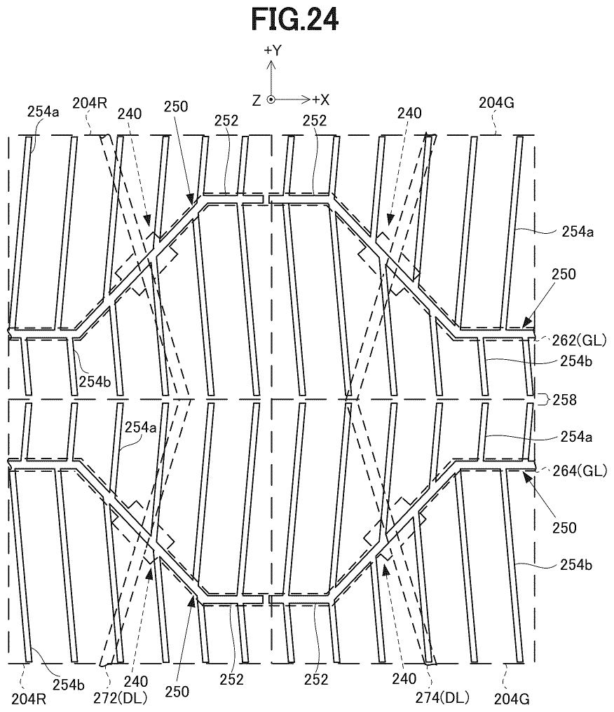

As illustrated in FIG. 24, the pixel electrodes 250 of the present embodiment are each arranged in a corresponding subpixel 204. As with the pixel electrodes 250 of Embodiment 2, the pixel electrodes 250 of the present embodiment each have a connector 252, first tooth portions 254a, and second tooth portions 254b. The connectors 252 overlap the first light blocking line 262 or the second light blocking line 264.

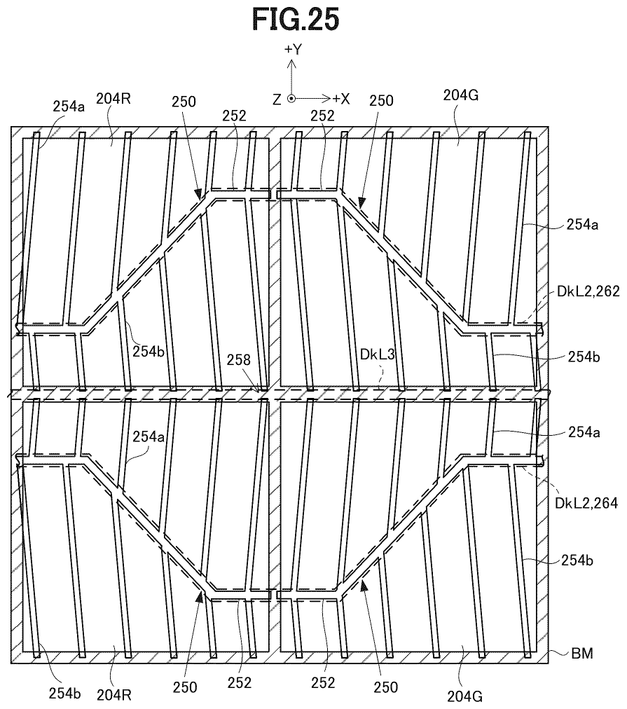

As in Embodiment 2, when voltage is applied to the second liquid crystal 230, one dark line extending in the X direction and being formed from a dark line due to the first light blocking line 262 and the dark line DkL2 due to the connectors 252, a dark line extending in the X direction and being formed from a dark line due to the second light blocking line 264 and the dark line DkL2 due to the connectors 252, and a dark line DkL3, extending in the X direction, due to the boundary 258 are generated. As illustrated in FIG. 25, the dark line DkL3 overlaps the black matrix BM. Therefore, only one dark line is generated as dark lines extending in the X direction within the subpixel 204. Note that, to facilitate comprehension, portions of the pixel electrodes 250 overlapping the black matrix BM are also illustrated by solid lines in FIG. 25.

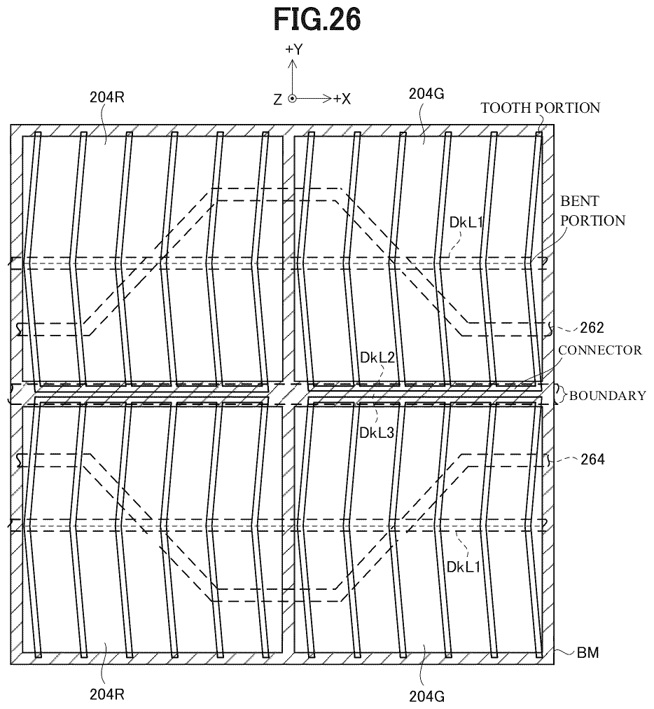

In a case where pixel electrodes providing by dividing the pixel electrode of Comparative Example 1 into two rows and two columns are applied in the present embodiment (hereinafter referred to as “Comparative Example 2”) instead of the pixel electrodes 250 of the present embodiment, as illustrated in FIG. 26, two dark lines (a dark line due to the first light blocking line 262 or the second light blocking line 264 and a dark line DkL1 due to the bent portions) are generated as dark lines extending in the X direction within the subpixels 204.

As described above, in the present embodiment as well, the connectors 252 of the pixel electrodes 250 overlap the first light blocking line 262 or the second light blocking line 264. As such, the number of dark lines generated within the subpixels 204 of the second liquid crystal display panel 200 when voltage is applied to the second liquid crystal 230 can be reduced. As a result, moiré of the liquid crystal display device 10 caused by the dark lines of the second liquid crystal display panel 200 and the first electrodes 612 of the touch panel 610 can be suppressed.

In the present embodiment as well, moiré of the liquid crystal display device 10 can be suppressed by the first light blocking pattern 260 and the second light blocking pattern 270. Furthermore, the aperture ratio of the second main pixel 202 and the transmittance of the liquid crystal display device 10 can be increased.

### Embodiment 5

In Embodiment 4, the panel section 50 of the liquid crystal display device 10 includes the second liquid crystal display panel 200 and the touch panel 610. The panel section 50 of the liquid crystal display device 10 may include a liquid crystal lens 630 instead of the touch panel 610. The liquid crystal lens 630 corresponds to the element.

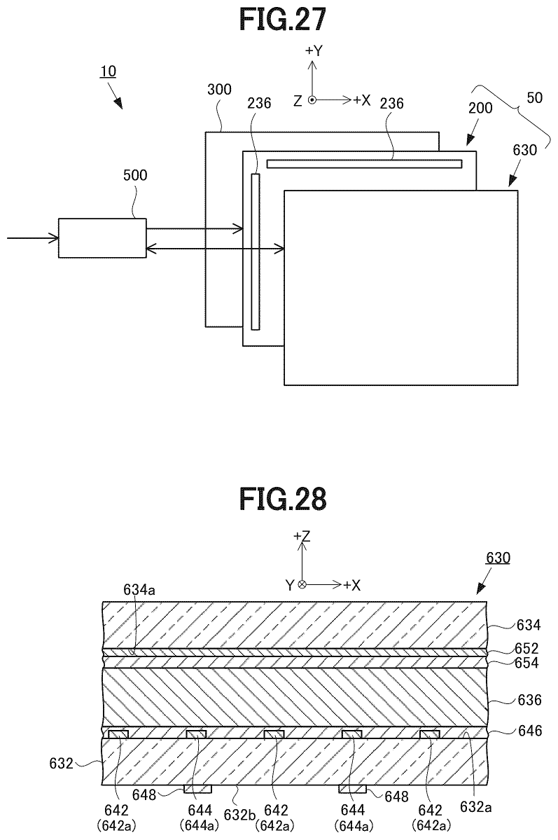

The liquid crystal display device 10 of the present embodiment displays two-dimensional characters, images, etc. and three-dimensional characters, images, etc. As illustrated in FIG. 27, the liquid crystal display device 10 of the present embodiment includes a panel section 50, a backlight 300, and a controller 500. The panel section 50 includes the second liquid crystal display panel 200 and the liquid crystal lens 630. The backlight 300 is a light source that emits light on the second liquid crystal display panel 200. The controller 500 controls the display of the second liquid crystal display panel 200. Furthermore, the controller 500 controls the liquid crystal lens 630.

The liquid crystal lens 630 of the panel section 50 is provided on a display surface side (the +Z side) of the second liquid crystal display panel 200 via a non-illustrated adhesive layer. The liquid crystal lens 630 switches, on the basis of a voltage application state, between a state of functioning as a lens and a state of not functioning as a lens. In the present embodiment, the liquid crystal lens 630 functions as a lenticular lens array in a state in which voltage is applied.

As illustrated in FIG. 28, the liquid crystal lens 630 includes a first light transmitting substrate 632, a second light transmitting substrate 634, and a liquid crystal 636. The first light transmitting substrate 632 and the second light transmitting substrate 634 sandwich the liquid crystal 636.

In one example, the first light transmitting substrate 632 is implemented as a glass substrate. The first light transmitting substrate 632 is adhered to the second liquid crystal display panel 200 via a non-illustrated adhesive layer.

A comb teeth-shaped third electrode 642, a comb teeth-shaped fourth electrode 644, an alignment film 646 are provided on a main surface 632a on the liquid crystal 636 side of the first light transmitting substrate 632. In one example, the third electrode 642 and the fourth electrode 644 are formed from ITO. The third electrode 642 and the fourth electrode 644 are connected to the controller 500 via a non-illustrated wiring.

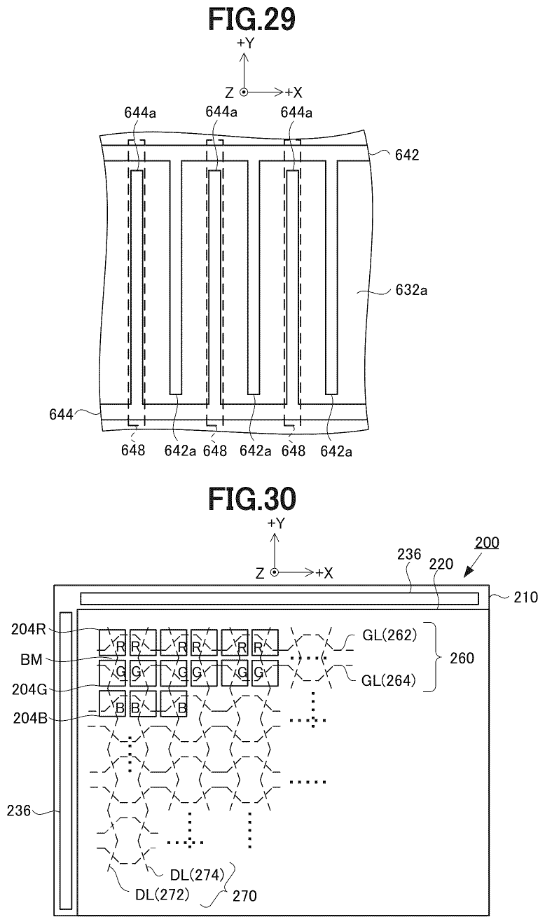

As illustrated in FIG. 29, the third electrode 642 includes a plurality of tooth portions 642a extending in the −Y direction. The fourth electrode 644 includes a plurality of tooth portions 644a extending in the +Y direction. The tooth portions 642a of the third electrode 642 and the tooth portions 644a of the fourth electrode 644 are disposed at equal intervals along the X direction in an alternating manner. In the present embodiment, when viewing the liquid crystal display device 10 from above, one pixel row of the second liquid crystal display panel 200 is positioned in a region between a tooth portion 642a and a tooth portion 644a that are adjacent to each other.

Returning to FIG. 28, in one example, the alignment film 646 is formed from polyimide. The alignment film 646 covers the third electrode 642, the fourth electrode 644, the main surface 632a of the first light transmitting substrate 632. The alignment film 646 aligns the liquid crystal 636 with the X direction.

The light shield 648 is provided on a main surface 632b on the side opposite the main surface 632a of the first light transmitting substrate 632. As illustrated in FIG. 29, the light shields 648 extend in the Y direction and overlap the tooth portions 644a of the fourth electrode 644. The light shields 648 block light that is emitted from the second liquid crystal display panel 200 and is incident on a region where the alignment of the liquid crystal 636 positioned above the tooth portion 644a is disturbed.

Returning to FIG. 28, in one example, the second light transmitting substrate 634 is implemented as a glass substrate. A counter-electrode 652 and an alignment film 654 are provided on a main surface 634a on the liquid crystal 636 side of the second light transmitting substrate 634. In one example, the counter-electrode 652 is formed in a rectangular shape from ITO on the main surface 634a of the second light transmitting substrate 634. The counter-electrode 652 faces the tooth portions 642a of the third electrode 642 and the tooth portions 644a of the fourth electrode 644. As with the third electrode 642 and the fourth electrode 644, the counter-electrode 652 is connected to the controller 500.

In one example, the alignment film 654 is formed from polyimide. The alignment film 654 covers the counter-electrode 652 and the main surface 634a of the second light transmitting substrate 634, and aligns the liquid crystal 636 in the X direction.

The liquid crystal 636 is sandwiched between the first light transmitting substrate 632 and the second light transmitting substrate 634. The liquid crystal 636 is implemented as a positive nematic liquid crystal. The liquid crystal 636 is in a homogeneous alignment with the X direction in a state in which voltage is not applied.

For example, due to control by the controller 500, when the potential of the third electrode 642, the fourth electrode 644, and the counter-electrode 652 is ground potential, voltage is not applied to the liquid crystal 636 and, as such, the homogeneous alignment of the liquid crystal 636 is maintained. While the homogeneous alignment of the liquid crystal 636 is maintained, the liquid crystal lens 630 does not function as a lenticular lens array. The liquid crystal display device 10 of the present embodiment displays two-dimensional characters, images, and the like, when the liquid crystal lens 630 is not functioning as a lenticular lens array.

Meanwhile, due to control by the controller 500, when the potential of the third electrode 642 and the potential of the counter-electrode 652 are made to be the same, and the potential of the fourth electrode 644 is made to be differ from the potential of the third electrode 642 and the potential of the counter-electrode 652, voltage is applied to the liquid crystal 636 and, as such, the alignment state of the liquid crystal 636 changes. In the present embodiment, this change in the alignment state of the liquid crystal 636 generates a refraction distribution along the X direction that corresponds to a lenticular lens occurred in a region, when viewed from above, between a pair of the tooth portions 644a of the fourth electrode 644 sandwiching one tooth portion 642a of the third electrode 642. In this case, the liquid crystal lens 630 functions as a lenticular lens array, and the liquid crystal display device 10 of the present embodiment displays three-dimensional characters, images, and the like.

With the exception of the configurations of color filter and pixel electrodes 250, the configuration of the second liquid crystal display panel 200 of the present embodiment is the same as the configuration of the second liquid crystal display panel 200 of Embodiment 4. Here, the color filter and the pixel electrodes 250 of the second liquid crystal display panel 200 are described.

As with the second liquid crystal display panel 200 in Embodiment 4, the second liquid crystal display panel 200 of the present embodiment includes a color filter and a black matrix BM on the second counter substrate 220, and performs color display. In the present embodiment, the color filter is implemented as a color filter of which a stripe direction is the X direction, and in which, as illustrated in FIG. 30, the subpixels 204 of the same color are disposed in the X direction.

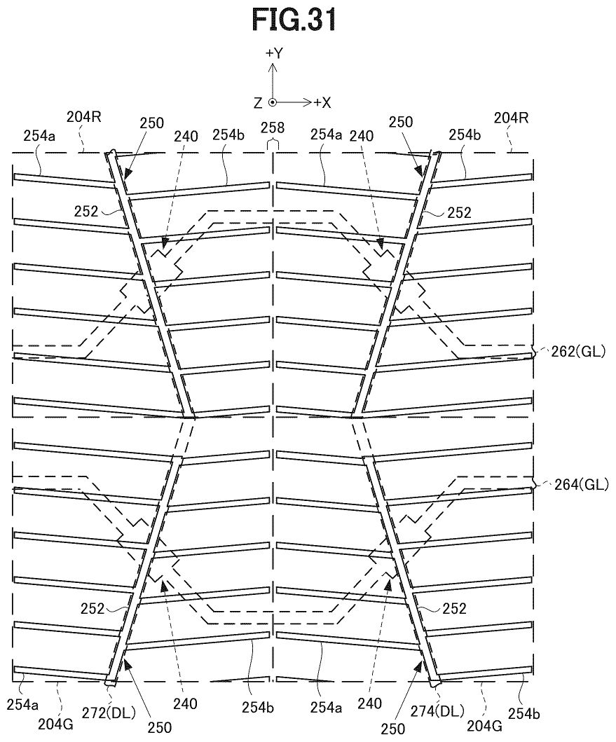

As illustrated in FIG. 31, the pixel electrodes 250 of the present embodiment are each arranged in a corresponding subpixel 204. As with the pixel electrodes 250 of Embodiment 3, the pixel electrodes 250 of the present embodiment each have a connector 252, first tooth portions 254a, and second tooth portions 254b. The connectors 252 overlap the third light blocking line 272 or the fourth light blocking line 274.

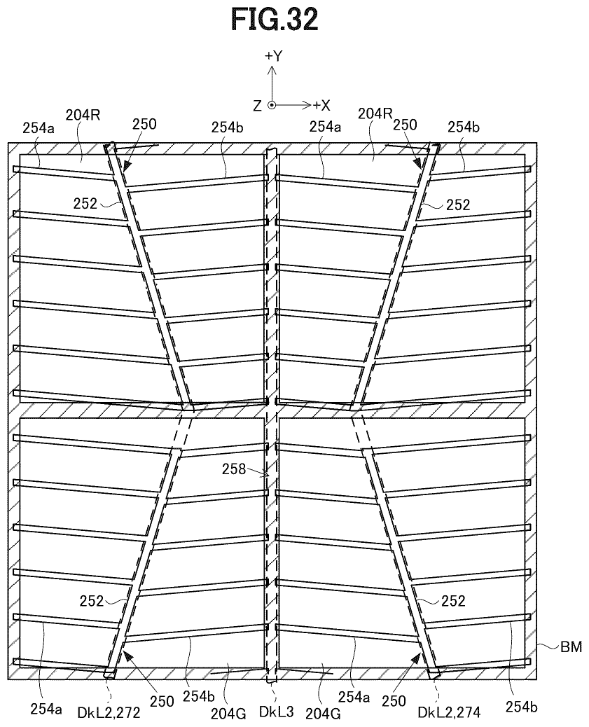

As in Embodiment 3, when voltage is applied to the second liquid crystal 230, one dark line extending in the Y direction and being formed from a dark line due to the third light blocking line 272 and the dark line DkL2 due to the connectors 252, one dark line extending in the Y direction and being formed from a dark line due to the fourth light blocking line 274 and the dark line DkL2 due to the connectors 252, and a dark line DkL3 extending in the Y direction due to the boundary 258 are generated. As illustrated in FIG. 32, the dark line DkL3 overlaps the black matrix BM. Therefore, only one dark line is generated as dark lines extending in the Y direction within the subpixels 204. Note that, to facilitate comprehension, the portions of the pixel electrodes 250 overlapping the black matrix BM are also illustrated by solid lines in FIG. 32.

As described above, the connectors 252 of the pixel electrodes 250 overlap the third light blocking line 272 or the fourth light blocking line 274. As such, the number of dark lines generated within the subpixels 204 of the second liquid crystal display panel 200 when voltage is applied to the second liquid crystal 230 can be reduced. As a result, moiré of the liquid crystal display device 10 caused by the light shields 648 or the tooth portions 642a of the liquid crystal lens 630 and the dark lines in the second liquid crystal display panel 200 can be suppressed.

In the present embodiment as well, moiré of the liquid crystal display device 10 can be suppressed by the first light blocking pattern 260 and the second light blocking pattern 270. Furthermore, the aperture ratio of the second main pixel 202 and the transmittance of the liquid crystal display device 10 can be increased.

### Modified Examples

While the embodiments have been described above, various modifications can be made to the present disclosure without departing from the scope thereof.

In the embodiments, the first liquid crystal display panel 100 operates by the horizontal electric field type method. However, the operating method of the first liquid crystal display panel 100 may be determined as desired.

In the embodiments, the first liquid crystal 130 and the second liquid crystal 230 are implemented a positive nematic liquid crystal. The first liquid crystal 130 may be implemented as a negative nematic liquid crystal. The second liquid crystal 230 may be implemented as a negative nematic liquid crystal.

In the embodiments, the first liquid crystal display panel 100 includes a color filter of which a stripe direction is the Y direction. The first liquid crystal display panel 100 includes a color filter of which a stripe direction is the X direction.

In the embodiments, one second main pixel 202 of the second liquid crystal display panel 200 corresponds to 16 first main pixels 102 of the first liquid crystal display panel 100. However, the number of first main pixels 102 of the first liquid crystal display panel 100 that one second main pixel 202 of the second liquid crystal display panel 200 corresponds to may be set as desired.

Additionally, the first light blocking line 262 of the first light blocking pattern 260 includes the first flat section 262c, and the second light blocking line 264 of the first light blocking pattern 260 includes the second flat section 264c. However, a configuration is possible in which the first light blocking line 262 does not include the first flat section 262c, and the second light blocking line 264 does not include the second flat section 264c. That is, a configuration is possible in which the first light blocking line 262 and the second light blocking line 264 have a line-symmetrical relationship with respect to the X direction, and each extend in a zig-zag in the X direction.

Meanwhile, a configuration is possible in which the third light blocking line 272 of the second light blocking pattern 270 includes a third flat portion that connects the fifth incline 272a and the sixth incline 272b to each other, and extends parallel to the Y direction. Additionally, a configuration is possible in which the fourth light blocking line 274 of the second light blocking pattern 270 includes a fourth flat portion that connects the seventh incline 274a and the eighth incline 274b to each other, and extends parallel to the Y direction.

The second light blocking pattern 270 (the third light blocking line 272 and the fourth light blocking line 274) in Embodiments 1, 2, and 4 may extend parallel to the Y direction instead of bending. The first light blocking pattern 260 (the first light blocking line 262 and the second light blocking line 264) in Embodiments 3 and 5 may extend parallel to the X direction instead of bending.

In the embodiments, the second liquid crystal display panel 200 includes the first light blocking pattern 260 and the second light blocking pattern 270. However, it is sufficient that the second liquid crystal display panel 200 includes at least one of the first light blocking pattern 260 or the second light blocking pattern 270.

In the embodiments, the scan wirings GL form the first light blocking line 262 and the second light blocking line 264 of the first light blocking pattern 260. It is sufficient that at least one of the first light blocking line 262 or the second light blocking line 264 of the first light blocking pattern 260 is formed from a scan wiring GL. For example, a configuration is possible in which, when the first light blocking line 262 is formed from a scan wiring GL, the second light blocking line 264 is a low-resistance wiring that connects the common electrodes CE. A configuration is possible in which the second light blocking line 264 is a light blocking body (light blocking pattern) formed from an organic material having light blocking properties. Additionally, in the second light blocking pattern 270 as well, it is sufficient that at least one of the third light blocking line 272 or the fourth light blocking line 274 is formed from a signal wiring DL.

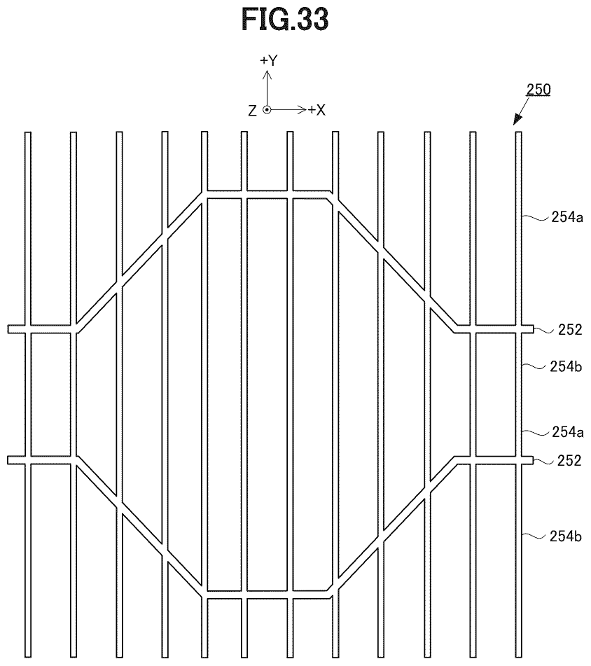

In the embodiments, the first tooth portions 254a and the second tooth portions 254b of the pixel electrodes 250 are inclined, at an acute angle, with respect to the X direction or the Y direction (the predetermined direction). The first tooth portions 254a and the second tooth portions 254b may extend parallel to the X direction or the Y direction. For example, as illustrated in FIG. 33, a configuration is possible in which the first tooth portions 254a of the pixel electrode 250 extend parallel to the +Y direction, and the second tooth portions 254b of the pixel electrode 250 extend parallel to the −Y direction.

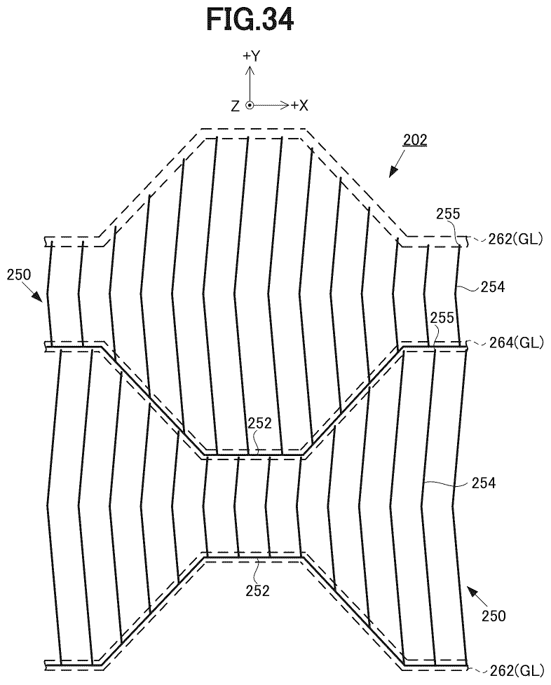

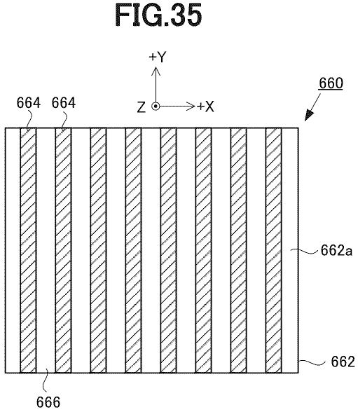

The shape of the second main pixel 202 of the second liquid crystal display panel 200 may be determined as desired. For example, as illustrated in FIG. 34, a configuration is possible in which the second main pixel 202 of the second liquid crystal display panel 200 has a non-rectangular shape. In the present modified example, the pixel electrode 250 includes a connector 252 overlapping the first light blocking line 262 or the second light blocking line 264 and the tooth portions 254 branched from the connector 252 and extending in the +Y direction. The tooth portions 254 bent and extend in the +Y direction, and the ends 255 of the tooth portions 254 overlap the first light blocking line 262 or the second light blocking line 264. Note that, to facilitate comprehension, the pixel electrodes 250 are illustrated by solid lines in FIG. 34.

The liquid crystal display device 10 in Embodiment 5 may include a parallax barrier panel 660 instead of the liquid crystal lens 630. In this case, the liquid crystal display device 10 displays three-dimensional characters, images, and the like using the parallax barrier method. As illustrated in FIG. 35, the parallax barrier panel 660 includes a third light transmitting substrate 662. The light shields 664 extending in the Y direction are arranged at equal intervals on a main surface 662a of the third light transmitting substrate 662, and light transmitters 666 are provided between the light shields 664. The parallax barrier panel 660 corresponds to the element.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A liquid crystal display device, comprising:
a first liquid crystal display panel having a first main pixel; and
a second liquid crystal display panel having a second main pixel corresponding to a plurality of the first main pixels and a light blocking pattern that is repeatedly arranged and has light blocking properties, and overlapping the first liquid crystal display panel, wherein
the light blocking pattern includes a first light blocking line that extends in a predetermined direction, the first light blocking line including a first incline inclined with respect to the predetermined direction and a second incline inclined in a direction opposite the first incline with respect to the predetermined direction, and a second light blocking line that is adjacent to the first light blocking line and that is line-symmetrical, with respect to the predetermined direction, to the first light blocking line,
the second main pixel has a pixel electrode, the pixel electrode having a plurality of tooth portions and a connector connecting the plurality of tooth portions,
at least one of the first light blocking line or the second light blocking line is formed from one of a scan wiring and a signal wiring of the second liquid crystal display panel, and
when viewed in plan, the connector overlaps the first light blocking line or the second light blocking line.

2. The liquid crystal display device according to claim 1, wherein
the plurality of tooth portions are formed from first tooth portions and second tooth portions that branch from the connector, extend in the direction opposite to each other across the connector, and are inclined, at an acute angle, in the direction opposite to each other with respect to the predetermined direction,
a spacing between the first tooth portions and a spacing between the second tooth portions are equal to each other, and
an angle of inclination of the first tooth portions relative to the predetermined direction is equal to an angle of inclination of the second tooth portions relative to the predetermined direction.

3. The liquid crystal display device according to claim 1, wherein
the plurality of tooth portions each have an end overlapping an adjacent first light blocking line or an adjacent second light blocking line that is adjacent to the first light blocking line or the second light blocking line that overlaps the connector.

4. A liquid crystal display device, comprising:
an element having an electrode or a light shield; and
a liquid crystal display panel having a main pixel and a light blocking pattern that is repeatedly arranged and has light blocking properties, and overlapping the element, wherein
the light blocking pattern includes a first light blocking line that extends in a predetermined direction, the first light blocking line including a first incline inclined with respect to the predetermined direction and a second incline inclined in a direction opposite the first incline with respect to the predetermined direction, and a second light blocking line that is adjacent to the first light blocking line and that is line-symmetrical, with respect to the predetermined direction, to the first light blocking line,
the main pixel has a pixel electrode, the pixel electrode having a plurality of tooth portions and a connector connecting the plurality of tooth portions,
at least one of the first light blocking line or the second light blocking line is formed from one of a scan wiring and a signal wiring of the liquid crystal display panel, and
when viewed in plan, the connector overlaps the first light blocking line or the second light blocking line.
